(19) United States
(12) Patent Application Publication
(10) Pub. No.: US 2024/0276969 A1
(43) Pub. Date: Aug. 22, 2024

(54) AUTOMATED FUNGICIDE SPRAY TIMING

(71) Applicant: PIONEER HI-BRED INTERNATIONAL, INC., JOHNSTON, IA (US)

(72) Inventors: JEREMIAH ROSS BARR, GRANGER, IA (US); STEVEN A. CRYER, LEBANON, IN (US); LAYTON ANDREW PEDDICORD, WAUKEE, IA (US)

(73) Assignee: PIONEER HI-BRED INTERNATIONAL, INC., JOHNSTON, IA (US)

(21) Appl. No.: 18/582,885

(22) Filed: Feb. 21, 2024

Related U.S. Application Data
(60) Provisional application No. 63/486,074, filed on Feb. 21, 2023.
(60) Provisional application No. 63/584,266, filed on Sep. 21, 2023.

(51) Int. Cl. A01M 7/00; A01B 79/00

(52) U.S. Cl. CPC A01M 7/0089; A01B 79/005

(57) ABSTRACT

Systems, methods, and apparatuses for spraying fungicide onto a crop are described. Soil data, environmental data, agronomic data, and crop genotype data may be acquired. A weather forecast for a region may be acquired based on the environmental data. Based on inputting the weather forecast, the soil data, the agronomic data, and the crop genotype data into a machine learning model, a predicted disease severity for the crop in the region over a plurality of time intervals may be determined. Based on the predicted disease severity and a sensitivity threshold, a fungicide timing schedule may be determined. The sensitivity threshold may indicate the predicted disease severity at which to initiate spraying the fungicide onto the crop. Based on the predicted disease severity meeting some criteria, the fungicide timing schedule may be sent to a fungicide spraying device that sprays the fungicide onto the crop based on the fungicide timing schedule.

### PRIORITY CLAIM

This application claims benefit to U.S. Provisional Application No. 63/486,074, filed on Feb. 21, 2023, and to U.S. Provisional Application No. 63/584,266, filed on Sep. 21, 2023. The disclosures of both provisional applications are incorporated herein by reference.

### FIELD OF USE

Aspects of the disclosure relate to automatically generating and implementing spray timing instructions for a crop. More specifically, aspects of the disclosure provide for the automatic intake and processing of data associated with soil conditions, a weather forecast, crop genotype, and agronomic practices in order to generate spray timing instructions that may be implemented by a fungicide spraying device.

### BACKGROUND

The consequences of sub-optimal spraying of crops with fungicides are many and include the direct financial costs of wasteful spraying, crop losses resulting from a greater proliferation of crop disease, and smaller crop yields. Determining the right time to spray a crop can be difficult, especially considering factors such as the individual requirements of different types of crops, varied approaches to crop cultivation, and a diversity of climates and growing environments. An approach to spraying one type of crop may not be applicable to a different crop, and the spray timing for the same type of crop may need to be changed depending on the growing environment or time of year. As a result, finding a reliable, low-risk, and effective way to spray crops may entail the consideration of a vast array of approaches, which may not be suitable or firmly grounded in science. Accordingly, opportunities to improve the way in which crops are sprayed to minimize crop disease may exist.

### SUMMARY

The following presents a simplified summary of various aspects described herein. This summary is not an extensive overview and is not intended to identify key or critical elements or to delineate the scope of the claims. The following summary merely presents some concepts in a simplified form as an introductory prelude to the more detailed description provided below.

Aspects described herein may allow for automatic methods, systems, non-transitory machine-readable media, and/or devices for the automated generation and implementation of spray timing instructions for a crop. More particularly, some aspects described herein may provide a system for spraying fungicide onto a crop based on a timing schedule that improves the benefits of the fungicide. The system may comprise a soil analyzer that may be configured to acquire samples of soil from a region comprising the crop; and generate soil data based on the samples of soil, or from regional soil databases that may exist. The system may further comprise an automated weather station that may be configured to monitor environmental conditions within the region comprising the crop; and generate environmental data based on the environmental conditions monitored by the automated weather station. The system may further comprise a computing device that may be configured to acquire agronomic data comprising information associated with a tillage practice, a crop history, and a fertilization history. The computing device may be further configured to acquire crop genotype data comprising a genotype and pathogen resistance characteristics of the crop. The computing device may be further configured to determine, based on the environmental data, a weather forecast for the region comprising the crop. The computing device may be further configured to generate, based on inputting the weather forecast, the soil data, the agronomic data, and the crop genotype data into the one or more machine learning models, a predicted disease severity for the crop in the region over a plurality of time intervals. The computing device may be further configured to generate, based on the predicted disease severity and a sensitivity threshold, a fungicide timing schedule comprising the plurality of time intervals at which to spray fungicide onto the crop. The sensitivity threshold may be associated with the predicted disease severity at which spraying the fungicide onto the crop may be initiated. The computing device may be further configured to, based on the predicted disease severity meeting one or more criteria, send the fungicide timing schedule to a fungicide spraying device. The system may comprise a fungicide spraying device configured to receive the fungicide timing schedule; and spray the fungicide onto the crop based on the fungicide timing schedule.

According to some aspects described herein, the fungicide spraying device may comprise an aerial sprayer configured to spray the fungicide onto the crop from an aircraft flying over the crop, a ground sprayer comprising an overhead spray boom that may be ground-based and configured to spray the fungicide onto the crop from above the crop, or an undercover sprayer that may be ground-based and configured to spray the fungicide onto the crop from beneath the crop.

According to some aspects described herein, the weather forecast may comprise a plurality of predicted humidities for the plurality of time intervals, a plurality of predicted rainfalls for the plurality of time intervals, and a plurality of predicted temperatures for the plurality of time intervals. Further, the computing device may be configured to determine, based on inputting the plurality of predicted humidities, the plurality of predicted rainfalls, and the plurality of predicted temperatures for the plurality of time intervals into the one or more machine learning models, one or more times at which dew or rain droplets may be predicted to form or persist on leaves of the crop. The formation or persistence of dew on the leaves of the crop may be positively correlated with the predicted disease severity.

According to some aspects described herein, the computing device may be configured to generate a user interface comprising a plurality of interface elements corresponding to a plurality of descriptions of the predicted disease severity. The plurality of descriptions may comprise a plurality of values associated with disease severity in the crop. The computing device may be further configured to generate, in the user interface, a prompt requesting an input to select one of the plurality of interface elements that indicates a predicted disease severity at which to spray the fungicide onto the crop; and determine the sensitivity threshold based on the input.

Some aspects described herein may provide a method of spraying fungicide onto a crop based on a fungicide timing schedule. The method may comprise: acquiring, by a computing device comprising one or more processors, soil data based on samples of soil from a region comprising the crop, or soil data based on information in soil databases. The method may comprise acquiring, by the computing device, environmental data based on environmental conditions within the region comprising the crop. The method may comprise acquiring, by the computing device, agronomic data comprising information associated with a tillage practice, a crop history, and a fertilization history. The method may comprise acquiring, by the computing device, crop genotype data comprising a genotype and pathogen resistance characteristics of the crop. The method may comprise determining, by the computing device, based on the environmental data, a weather forecast for the region comprising the crop. The method may comprise generating, by the computing device, based on inputting the weather forecast, the soil data, the agronomic data, and the crop genotype data into the one or more machine learning models, a predicted disease severity for the crop in the region over a plurality of time intervals. The method may comprise generating, by the computing device, based on the predicted disease severity and a sensitivity threshold, a fungicide timing schedule comprising the plurality of time intervals at which to spray at least one fungicide onto the crop. The sensitivity threshold may be associated with the predicted disease severity at which spraying the fungicide onto the crop may be initiated. The method may comprise, based on the predicted disease severity meeting one or more criteria, causing, by the computing device, a change in the fungicide timing schedule of a fungicide spraying device configured to spray the at least one fungicide onto the crop.

According to some aspects described herein, the one or more machine learning models may comprise a leaf wetness model configured to determine leaf wetness for the crop in the region based on the environmental data. The environmental data may comprise information associated with dew formation, precipitation, or temperature in the region. The leaf wetness of the crop may be positively correlated with the predicted disease severity of the crop.

According to some aspects described herein, the predicted disease severity may be positively correlated with a proportion of leaves of the crop that may be predicted to be covered in foliar lesions.

According to some aspects described herein, the agronomic data may comprise a planting date of the crop, a planting rate of the crop, a planting density of the crop, an irrigation practice, a nitrogen fertilizer amount per square meter of the region, or a crop rotation history for the crop.

According to some aspects described herein, the soil data may comprise a cation exchange capacity of soil in the region, an organic matter percentage of the soil, a sand percentage of the soil, a silt percentage of the soil, a clay percentage of the soil, a potential of hydrogen (pH) of the soil, or a slope of surface of the soil.

According to some aspects described herein, the crop genotype data may comprise one or more disease tolerance scores indicating a resistance of the crop to one or more pathogens. Further, the predicted disease severity may be inversely correlated with the one or more disease tolerance scores of the crop. Each of the one or more pathogens may be associated with a temperature range or a humidity range that increase the predicted disease severity for the crop.

According to some aspects described herein, the one or more machine learning models may be configured to determine the predicted disease severity in a plurality of sub-regions of the region. Further, according to some aspects described herein the method may further comprise generating a disease severity map for the region, and the disease severity map may comprise a plurality of indications of the predicted disease severity in each of the plurality of sub-regions.

According to some aspects described herein, the crop may be corn, and one or more machine learning models may be configured to determine the predicted disease severity caused by one or more diseases comprising northern corn leaf blight, gray leaf spot, or tar spot.

According to some aspects described herein, environmental data may comprise growing degree days associated with the crop. Further, the growing degree days may be positively correlated with the predicted disease severity.

According to some aspects described herein, the crop may be corn, and one or more machine learning models may be configured to determine a silking time for the corn. Further, the fungicide timing schedule may be based on the silking time for the corn.

According to some aspects described herein, the crop may be corn, and the predicted disease severity corresponds to a predicted severity of foliar disease on the corn, a predicted severity of seed rot in the corn, a predicted severity of seedling blight in the corn, a predicted severity of stalk rot in the corn, or a predicted severity of ear rot in the corn.

According to some aspects described herein, the one or more machine learning models comprise a neural network, a random forest model, a linear model, or a support vector regressor. Further, the one or more machine learning models may be configured to determine a risk of the crop being infected by one or more pathogens.

According to some aspects described herein, the environmental data may comprise historical weather conditions for a region, a short-term forecast of weather conditions within a short-term time period, or a long-term forecast of weather conditions within a long-term time period comprising a time period subsequent to the short-term time period.

According to some aspects described herein, the fungicide may comprise two or more types of fungicide. Further, the fungicide timing schedule may comprise a recommendation of an amount of the two or more types of fungicide to spray onto the crop.

According to some aspects described herein, the soil data may comprise a soil moisture for the region or an available water content for the region. Further, the soil moisture or the available water content may be positively correlated with the predicted disease severity.

According to some aspects described herein, the predicted disease severity may be associated with a plurality of disease severity scores. Further, the plurality of disease severity scores may be positively correlated with disease severity, and the predicted disease severity may meet the one or more criteria based on at least one of the plurality of disease severity scores exceeding the sensitivity threshold.

According to some aspects described herein, the two or more types of fungicide are selected from the group consisting of: mefentrifluconazole and pyraclostrobin; axoxystrobin and propiconazole; benzovindiflupyr, azoxystrobin and propiconazole; bixafen and flutriafol; azoxystrobin, propiconazole, and pydiflumetofen; flutriafol and azoxystrobin; picoxystrobin and cyproconazole; fluoxastrobin and flutriafol; fluoxastrobin and flutriafol; prothioconazole and trifloxystrobin; mefentrifluconazole, pyraclostrobin, and fluxapyroxad; fluxapyroxad and pyraclostrobin; tetraconazole and azoxystrobin; prothioconazole and trifloxystrobin; prothioconazole, trifloxystrobin, and fluoryram; and fluopyram and prothioconazole.

Some aspects described herein may provide one or more non-transitory computer readable media comprising instructions that, when executed by at least one processor, cause a computing device to perform operations. The operations may comprise acquiring soil data based on samples of soil from a region comprising a crop. The operations may comprise acquiring environmental data based on environmental conditions within the region comprising the crop. The operations may comprise acquiring agronomic data comprising information associated with a tillage practice, a crop history, and a fertilization history. The operations may comprise acquiring crop genotype data comprising a genotype and pathogen resistance characteristics of the crop. The operations may comprise determining, based on the environmental data, a weather forecast for the region comprising the crop. The operations may comprise generating, based on inputting the weather forecast, the soil data, the agronomic data, and the crop genotype data into the one or more machine learning models, a predicted disease severity for the crop in the region over a plurality of time intervals. The operations may comprise generating, based on the predicted disease severity and a sensitivity threshold, a fungicide timing schedule comprising the plurality of time intervals at which to apply fungicide to the crop. The sensitivity threshold may be associated with the predicted disease severity at which application of the fungicide to the crop may be initiated. The operations may comprise, based on the predicted disease severity meeting one or more criteria, sending the fungicide timing schedule to a fungicide application device configured to apply the fungicide to the crop.

Corresponding apparatuses, devices, systems, and/or computer-readable media (e.g., non-transitory computer readable media) are also within the scope of the disclosure. By more accurately generating a spray timing schedule and implementing spray timing instructions based on the spray timing schedule, the benefits of optimized spraying of fungicide onto crops may be achieved. These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 shows an example of a computing system that may be used to implement one or more aspects of the disclosure in accordance with one or more illustrative aspects discussed herein.

FIG. 2 shows an example of a machine learning model according to one or more aspects of the disclosure.

FIG. 3 shows an example of decision tree feature importance according to one or more aspects of the disclosure.

FIG. 4 shows relationships between leaf wetness and features of environmental data according to one or more aspects of the disclosure.

FIG. 5 shows cumulative risk of crop disease over time according to one or more aspects of the disclosure.

FIG. 6 shows an example of data flows according to one or more aspects of the disclosure.

FIG. 7 shows an example flow chart for automated acquisition of samples of soil and monitoring of environmental conditions according to one or more aspects of the disclosure.

FIG. 8 shows an example flow chart for automated generation of a fungicide spray timing schedule according to one or more aspects of the disclosure.

FIG. 9 shows an example flow chart for determination of a sensitivity threshold via a user interface according to one or more aspects of the disclosure.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof. Further, the disclosure refers to specific crops including “corn,” “cotton,” “soybean,” and “wheat.” The use of a specific crop when describing an embodiment should not be regarded as limiting the embodiment to being practiced using a particular type of crop. Rather, various embodiments described herein may be practiced using various types of crops.

Aspects described herein are generally directed to generating more effective fungicide timing schedules that may be used by a fungicide spraying device. A more effective fungicide timing schedule may be used to apply fungicide to crops in a more beneficial manner. The determination of when to spray fungicide onto a crop to achieve improved outcomes may be influenced by a variety of factors including the impact of weather, disease risk, and fungicide application costs. Improper timing of fungicide spraying may lead to lower yield, increased expenses, and generally lower efficiency of resource usage. In some cases fungicide spray timing information may be applicable to another crop genotype but not to the crop genotype being sprayed. In other cases, fungicide spray timing may be based on information (e.g., the time at which fungicide was sprayed in the previous year) that may no longer be valid due to changed conditions in the growing environment (e.g., soil and/or environmental conditions). Further, in instances when the same type of crop is grown under similar growing conditions, the agronomic practices used may be different, and more effective fungicide application may require a different spray timing schedule. As described herein, through the novel implementation of sophisticated data analysis techniques and the generation of a fungicide timing schedule, a more effective timing of fungicide application may be used on a variety of crops.

In particular, the disclosed technology may use machine-learning models, to generate a predicted disease severity associated with a particular crop (e.g., corn, cotton, canola, soybean, grapes, rice, potatoes, sugar cane, linen, hemp, oats, barley, sorghum, various fruits, various legumes, various vegetables, and/or wheat). The input to the machine learning models may be based on data associated with samples of soil (e.g., data received from a soil sample database and/or data based on soil samples gathered from a region), environmental conditions (e.g., weather conditions), agronomic practices, and crop genotype for a crop within a region. Further, the machine learning models may use the input to generate a predicted disease severity for the crop within the region. Based on the predicted disease severity and a sensitivity threshold, a fungicide timing schedule that indicates the times at which to spray fungicide onto the crop may be generated.

According to the aspects described herein, these and other technical effects and benefits may be achieved through use of the disclosed fungicide timing schedule. These novel techniques may result in a reduction in disease related crop losses while also allowing for a more efficient use of fungicide resources. Further, more effectively timing the spraying of crops may lead to other benefits including increased crop yield. By way of introduction, aspects discussed herein may relate to systems, methods, and techniques for generating fungicide timing schedules that may be implemented by fungicide spraying devices.

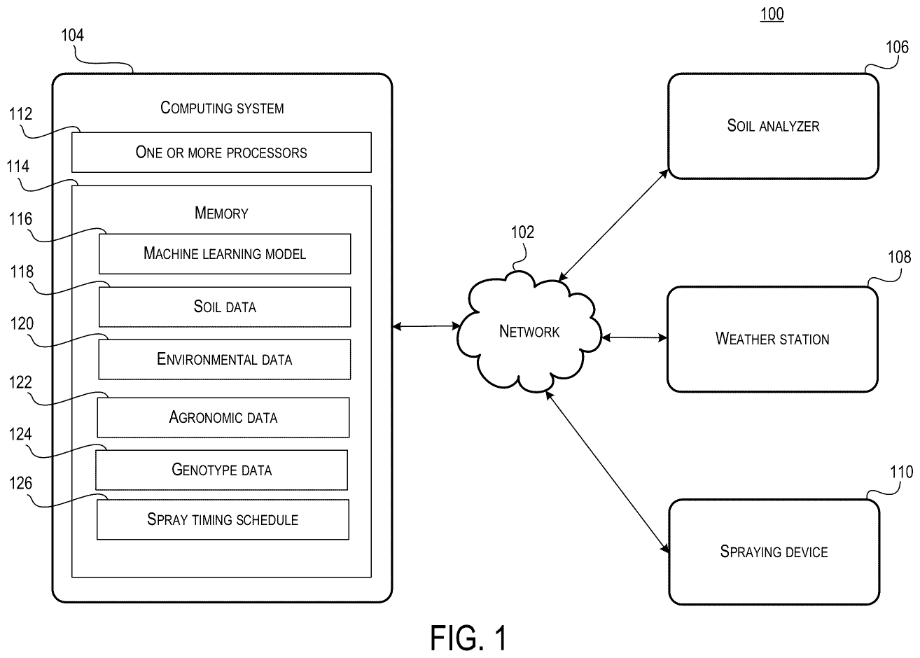

Before discussing these concepts in greater detail, however, several examples of computing devices and/or computing systems that may be used in implementing and/or otherwise providing various aspects of the disclosure will first be discussed with respect to FIG. 1.

FIG. 1 shows an example of a system in accordance with aspects of the present disclosure. In particular, FIG. 1 depicts a diagram of a computing system that may be configured to perform operations comprising the exchange and processing of signals and/or data that may be used to generate a fungicide spray timing schedule for use in spraying fungicide onto crops. As shown in FIG. 1, the computing system includes the network 102, a computing system 104, a soil analyzer 106, a weather station 108, and a spraying device 110. Computing system 104 may comprise one or more processors 112, memory 114, one or more machine learning models 116, soil data 118, environmental data 120, agronomic data 122, crop genotype data 124, and/or a spray timing schedule 126. System 100 may operate in a standalone environment and/or as part of a networked environment that may include other devices and/or systems. For example, system 100 may operate in conjunction with other computing systems and/or other computing devices not shown in FIG. 1. As shown in FIG. 1, various computing devices including computing system 104, soil analyzer 106, weather station 108, and/or spraying device 110 may be interconnected via the network 102. Further, the system 100 may operate via one or more networks not including the network 102 shown in FIG. 1.

Network 102 may be used to communicate (e.g., send and/or receive) signals, information, and/or data. For example, network 102 may be used to communicate environmental data 120 that may be sent from weather station 108 to computing system 104. Network 102 may include any combination of wired and/or wireless networks and may carry any type of signal or communication including communications and/or signals using one or more communication protocols (e.g., TCP/IP, HTTP, and/or HTTPS). Further, network 102 may include any combination of a local area network (LAN), an intranet, a wide area network (WAN), and/or the Internet. Furthermore, network 102 may be configured or arranged according to any known topology and/or architecture.

Computing system 104 may, in some embodiments, implement one or more aspects of the present disclosure by accessing and/or executing instructions; and/or performing one or more operations based at least in part on the instructions. For example, computing system 104 may generate instructions (e.g., spray timing schedule 126) that may be used by the spraying device 110 (e.g., a fungicide spraying device). In some embodiments, the system 100 may be incorporated into and/or include a computing device (e.g., a computing device with one or more processors, one or more memory devices, one or more input devices, and/or one or more output devices). For example, computing system 104 may be incorporated into and/or include a desktop computer, a computer server, a computer client, a mobile device (e.g., a laptop computer, a tablet computer, a smart phone, and/or a smart watch), and/or any other type of processing device.

Computing system 104 may include one or more interconnects for communication between different components of the computing device. Computing system 104 may also include a network interface via which computing system 104 may exchange one or more signals including information and/or data with other computing systems and/or computing devices. For example, computing system 104 may send information and/or data (e.g., the spray timing schedule 126) to spraying device 110 via the network 102. By way of further example, computing system 104 may receive information and/or data, via the network 102, from soil analyzer 106 and/or weather station 108 and may acknowledge that the information and/or data was received. Further, computing system 104 may include one or more input devices (e.g., a keyboard, mouse, touch screen, stylus, and/or microphone) and/or one or more output devices (e.g., a display device and/or audio output devices including loudspeakers).

Computing system 104 may include one or more computing devices. Further, as seen in FIG. 1, computing system 104 may include one or more processors 112 and a memory 114. The one or more processors 112 may include any combination of processing devices (e.g., one or more computer processing units (CPUs), one or more graphics processing units (GPUs), one or more processor cores, one or more microprocessors, one or more application specific integrated circuits (ASICs), one or more field programmable gate arrays (FPGAs), and/or one or more controllers). By way of example, computing system 104 may comprise the one or more processors 112 and memory 114 that may store instructions that, when executed by the one or more processors 112, causes computing system 104 to perform operations which may include the operations described herein. The one or more processors 112 may execute instructions including instructions stored in the memory 114. Further, the one or more processors 112 may be arranged in various configurations including any combination of one or more serial processors and/or one or more parallel processors.

The memory 114 may include one or more computer-readable media (e.g., non-transitory computer-readable media) and may be configured to store data and/or instructions including one or more machine learning models 116 and/or soil data 118. Further, the memory 114 may include one or more memory devices including random access memory (RAM), read only memory (ROM), programmable read only memory (PROM), erasable programmable read only memory (EPROM), electrically erasable programmable read only memory (EEPROM), solid state drives (SSDs), hard disk drives (HDDs), and/or hybrid memory devices that use a combination of different types of memory technologies.

As shown in FIG. 1, the memory may be used to store data which may comprise one or more machine learning models 116, soil data 118, environmental data 120, agronomic data 122, and/or crop genotype data 124. One or more machine learning models 116 may include instructions that may be used perform operations based on data comprising soil data 118, environmental data 120, agronomic data 122, and/or crop genotype data 124. As described herein, one or more machine learning models 116 may be configured to generate a predicted disease severity for a crop based on soil data 118, environmental data 120, agronomic data 122, and/or crop genotype data 124, associated with a crop. Further, one or more machine learning models 116 may be configured to generate output comprising spray timing schedule 126, which may be used by spraying device 110 to spray fungicide onto crops based on information (e.g., times to spray) from spray timing schedule 126.

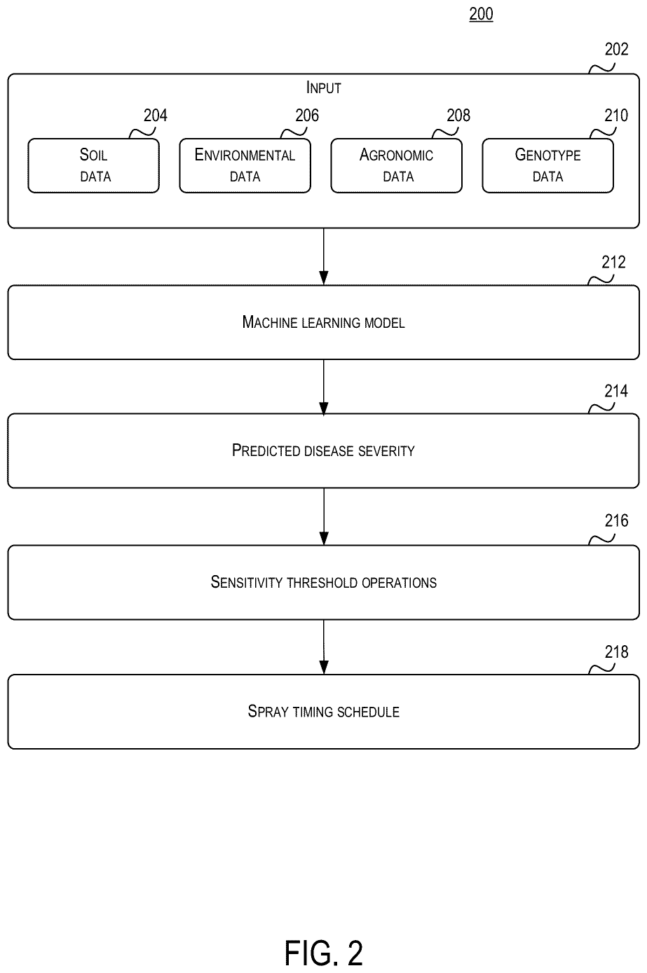

Soil data 118 may include information associated with samples of soil that were acquired and/or analyzed by soil analyzer 106. Further, soil data 118 may comprise information indicating the state of soil in a region in which a crop may be grown and may be used in the generation of a predicted disease severity and/or spray timing schedule 126 as described herein. Soil data 118 may include the information and/or features of soil data 204 described herein with respect to FIG. 2.

Environmental data 120 may include information associated with the current, past, and/or predicted state (e.g., weather conditions, temperature, humidity, and/or barometric pressure) of the environment of a region in which a crop may be grown. Environmental data 120 may be based on information acquired by the weather station 108. Further, environmental data 120 may be used in the generation of a predicted disease severity and/or spray timing schedule 126 as described herein. Environmental data 120 may include the information and/or features of environmental data 206 described herein with respect to FIG. 2.

The agronomic data 122 may include information associated with one or more tillage practices, a crop history, and/or a fertilization history associated with a crop grown within a region. The agronomic data 122 may associated with a region from which the soil analyzer 106 acquires samples of soil and generates soil data 118; and/or the weather station 108 monitors environmental conditions and generates environmental data 120. Further, agronomic data 122 may be used in the generation of a predicted disease severity and/or spray timing schedule 126 as described herein. Agronomic data 122 may include the information and/or features of agronomic data 208 described herein with respect to FIG. 2.

Crop genotype data 124 may include information associated with the genotype of a crop. Crop genotype data 124 may be associated with a crop grown in a region from which the soil analyzer 106 acquires samples of soil and generates soil data 118; and/or the weather station 108 monitors environmental conditions and generates environmental data 120. Further, crop genotype data 124 may be used in the generation of a predicted disease severity and/or fungicide timing schedule as described herein. Crop genotype data 124 may include the information and/or features of crop genotype data 210 described herein with respect to FIG. 2.

Spray timing schedule 126 (e.g., a fungicide timing schedule) may include information that indicates one or more times at which one or more fungicides, water, and/or one or more pesticides may be applied (e.g., sprayed) onto crops in a region. For example, spray timing schedule 126 may be used by spraying device 110 to determine one or more times at which to spray fungicide, water, and/or pesticide onto crops in a region. Spray timing schedule 126 may include the information and/or features of spray timing schedule 218 described herein with respect to FIG. 2.

The soil analyzer 106 may include a mechanized and/or electronic device that may be configured to acquire and/or analyze samples of soil from soil of a region in which a crop grows. In some embodiments, the soil analyzer 106 may gather soil samples from soil used to grow crops including corn, cotton, canola, soybeans, grapes, rice, potatoes, sugar cane, linen, hemp, oats, barley, sorghum, various fruits, various legumes, various vegetables, and/or wheat. The soil analyzer 106 may generate soil data 118 based on the samples of soil acquired and/or analyzed by the soil analyzer 106. Further, soil data may be based on regional soil databases (e.g., soil survey geographic database (SSURGO) and/or state soil geographic database (STATSGO)). For example, the soil analyzer 106 may comprise one or more sensors that may be used to determine the amount of moisture or available water content in a soil sample. The soil analyzer 106 may include any of the features and/or components of computing system 104. For example, a soil analyzer 106 may include one or more processors, a memory, one or more input devices, and/or one or more output devices. Further, a soil analyzer 106 may have different or similar configurations and/or architectures to that of computing system 104.

Weather station 108 may include a device that may be configured to determine the weather conditions in a region. For example, the weather station 108 may comprise one or more sensors (e.g., thermometers, barometers, humidity sensors, rain gauges, anemometers, satellite based cameras to provide images of cloud cover and other environmental features) that may be used to determine environmental conditions comprising temperature (e.g., air temperature at one or more portions of a region in which a crop is grown), humidity, barometric pressure, rainfall (e.g., hourly, daily, weekly, monthly, quarterly, or annual rainfall), wind direction (e.g., a wind direction at different portions of a region in which a crop is grown), and/or wind speed (e.g., a wind speed at different portions of a region in which a crop is grown). In some embodiments, weather station 108 may be operated from within the region by an entity that may generate environmental data and/or weather forecasts based on weather conditions in a region. For example, weather station 108 may be operated by an entity (e.g., a crop manager) that manages the crop within the region. Further, the weather station 108 may be operated by and/or receive information from a third-party entity that generates environmental data and/or weather forecasts for one or more regions including the region in which the crop is grown. For example, weather station 108 may receive environmental data and/or weather forecasts based on information from the National Digital Forecast Database (NDFD).

Weather station 108 may be located within a region in which a crop may be grown and may provide environmental data based on one or more weather conditions detected within range of the one or more sensors of the weather station 108. In some embodiments, the weather station 108 may be at a location that is remote from the region in which a crop is grown. For example, the weather station 108 may provide environmental data based on information (e.g., satellite imagery) from one or more sensors that are located outside of the region in which a crop is grown. The environmental data from the weather station 108 may be sent to computing system 104, which may in turn process the environmental data as described herein. The weather station 108 may include any of the features and/or components of computing system 104. For example, a weather station 108 may include one or more processors, a memory, one or more input devices, and/or one or more output devices. Further, a weather station 108 may have different or similar configurations and/or architectures to that of computing system 104.

The spraying device 110 may include a mechanized and/or electronic device that may be configured to apply (e.g., spray) fungicide and/or other substances (e.g., water, and/or pesticide including herbicide and/or insecticide) onto crops. For example, the spraying device 110 may comprise a fungicide spraying device, a water spraying device, and/or a pesticide spraying device. Further, the spraying device 110 may be configured to spray any combination of fungicide, water, and/or pesticide onto crops. In some embodiments, the spraying device 110 may apply fungicide, water, pesticide, and/or other substances onto one or more crops comprising corn, cotton, canola, soybeans, grapes, rice, potatoes, sugar cane, linen, hemp, oats, barley, sorghum, various fruits, various legumes, various vegetables, and/or wheat. The spraying device 110 may comprise an aerial sprayer configured to spray the fungicide onto a crop from an aircraft (e.g., an airplane, a helicopter, or an unmanned aerial vehicle) that may be configured to fly over the crop. For example, the spraying device 110 may comprise a drone aircraft that has been programmed to fly over a region in which a crop may be grown and spray fungicide onto the crop (e.g., broad spot treatment and/or broadcast application) in accordance with a fungicide timing schedule. Further, the spraying device 110 may comprise a ground sprayer comprising an overhead spray boom that may be ground-based and configured to spray the fungicide onto the crop from above the crop. For example, the spraying device 110 may comprise a plurality of overhead spray booms that are positioned above the ground in which crops are grown and through which fungicide may be sprayed onto the based on a fungicide timing schedule. Further, the spraying device 110 may comprise an undercover sprayer that may be ground-based and configured to spray the fungicide onto a crop from beneath the crop. For example, the spraying device 110 may comprise a plurality of undercover sprayers that are positioned to spray beneath the leaves of the crop based on a fungicide timing schedule. The spraying device 110 may include any of the features and/or components of computing system 104. For example, a spraying device 110 may include one or more processors, a memory, one or more input devices, and/or one or more output devices. Further, a spraying device 110 may have different or similar configurations and/or architectures to that of computing system 104.

One or more aspects described herein may be embodied in computer-usable, computer-readable data, and/or computer-executable instructions, which may be stored as data and/or instructions in one or more memory devices and/or executed by one or more computing devices and/or other devices described herein. Data and/or instructions may include software applications and/or computer programs that may be used to perform the operations described herein (e.g., generating fungicide timing schedules) when executed by one or more processors in a computing device or other device. The data and/or instructions be written in source code that is compiled for execution by a computing device. The computer executable instructions may be stored on a computer readable medium (e.g., a non-transitory computer-readable medium) such as a hard disk, solid state drive, optical disk, removable storage media, solid state memory, and/or RAM. The functionality of the computing applications described herein may be combined or distributed in various embodiments. Further, the functionality of the computing applications described herein may be partly or wholly embodied in firmware or hardware equivalents including integrated circuits and/or field programmable gate arrays (FPGA).

FIG. 2 shows an example of a machine learning model according to one or more aspects of the disclosure. One or more machine learning models 212 may be implemented on the computing system 100 illustrated in FIG. 1, according to an embodiment of the invention.

Input 202 may comprise various data and/or information that may be used singly or in combination as an input to one or more machine learning models 212. As shown in FIG. 2, input 202 comprises soil data 204, environmental data 206, agronomic data 208, and crop genotype data 210. Input 202 may be based on data received from a variety of sources (e.g., the computing system 100 described with respect to FIG. 1 and/or a remote computing system that provides data) and one or more portions of data may be added to or removed from input 202.

Input 202 may comprise soil data 204 which may comprise data and/or information associated with soil conditions in a geographic region. Soil data 204 may be based on samples of soil acquired from a geographic region (e.g., samples of soil acquired by the soil analyzer 106 described with respect to FIG. 1 and/or soil data acquired from a soils database). Further, soil data 204 may comprise information associated with a cation exchange capacity of soil in the region. The cation exchange capacity of soil may indicate the capacity of soil to hold positively charged cations. A high cation exchange capacity may be inversely correlated with predicted disease severity.

Soil data 204 may comprise information associated with an organic matter percentage of the soil upper layers. The organic matter percentage may indicate a proportion of animal tissue and/or plant matter in the soil. The animal tissue and/or plant matter in the soil may be in a state of decomposition and an organic matter percentage within a predetermined range may be inversely correlated with predicted disease severity. An organic matter percentage outside the predetermined range (e.g., higher or lower than the predetermined range) may be associated with higher predicted disease severity. For example, a predetermined organic matter percentage range for a crop genotype may be an organic matter percentage of 3-6%, which may be determined to be a range within which predicted disease severity may be low, with an organic matter percentage that is higher or lower than the predetermined organic matter percentage range resulting in higher predicted disease severity.

Soil data 204 may comprise information associated with a sand percentage of the soil. The sand percentage of soil may indicate a proportion of sand in soil and further, may indicate the proportion of sand relative to a proportion of silt and/or clay in the soil (e.g., soil texture). A predetermined range of sand percentage may be positively correlated with low predicted disease severity. A sand percentage outside the predetermined range (e.g., higher or lower than the predetermined range) may be associated with higher predicted disease severity. For example, the predetermined range for a crop genotype may be a sand percentage of 35-45%, which may be determined to be a range within which predicted disease severity may be low, with a higher or lower sand percentage being associated with higher predicted disease severity.

Soil data 204 may comprise information associated with a silt percentage of the soil. The silt percentage of soil may indicate a proportion of silt in soil and further, may indicate the proportion of silt relative to a proportion of sand and/or clay in the soil. A predetermined range of silt percentage may be associated with low predicted disease severity. An silt percentage outside the predetermined range (e.g., higher or lower than the predetermined range) may be associated with greater predicted disease severity. For example, the predetermined range for a crop genotype may be a silt percentage of 35-45%, which may be determined to be a range within which predicted disease severity may be low, with a higher or lower silt percentage resulting in higher predicted disease severity.

Soil data 204 may comprise a clay percentage of the soil. The clay percentage of soil may indicate a proportion of clay in soil and further, may indicate the proportion of clay relative to a proportion of silt and/or sand in the soil. A predetermined range of clay percentage may be associated with predicted disease severity. A clay percentage outside of one or more predetermined ranges may be associated with lower predicted disease severity. If soil is associated with a single predetermined range of clay percentage, then a clay percentage that is higher or lower than the predetermined range may be associated with lower predicted disease severity. For example, the predetermined range for a crop genotype may be a clay percentage of 15-25%, which may be determined to be a range within which predicted disease severity may be low, with a higher or lower clay percentage resulting in a higher predicted disease severity. Further, if soil is associated with multiple predetermined ranges of clay percentage, then a clay percentage that is outside any of the predetermined ranges of clay percentage may be associated with lower predicted disease severity.

Soil data 204 may comprise information associated with a potential of hydrogen (pH) of the soil. The pH may indicate how acidic soil may be. A predetermined pH range may be associated with a low predicted disease severity. A pH outside of the predetermined range (e.g., higher or lower than the predetermined range) may be associated with higher predicted disease severity. For example, the predetermined range for a crop genotype may be a pH between 6.5 and 7.5, which may be determined to be a range within which predicted disease severity may be low, with a higher or lower pH resulting in a higher predicted disease severity.

Soil data 204 may comprise information associated with a slope of surface of the soil. The slope of surface of soil may indicate an incline of the soil surface relative to the horizontal. A predetermined slope of surface of soil may be associated with a low predicted disease severity. A slope of surface of soil outside the predetermined range (e.g., higher or lower than the predetermined range) may be associated with higher predicted disease severity. For example, the predetermined range for a crop genotype may be a slope of surface of soil of 0-20%, which may be determined to be a range within which predicted disease severity may be low, with a higher or lower slope of surface of soil resulting in a higher predicted disease severity.

Soil data 204 may comprise information associated with a soil moisture for a region and/or an available water content for the region. Further, the soil moisture and/or the available water content may be positively correlated with the predicted disease severity. For example, an amount of soil moisture and/or available water content that exceeds a predetermined threshold amount of soil moisture and/or available water content may result in growing conditions that result in a faster proliferation of pathogens and/or a greater proportion of crops that are adversely affected by disease. The faster proliferation of pathogens and/or greater proportion of crops that are affected may be positively correlated with a greater predicted disease severity.

Input 202 may comprise environmental data 206 which may comprise information associated with the state of an environment in a region (e.g., weather patterns in a region). Environmental data 206 may be based on weather conditions of a geographic region (e.g., weather conditions determined and/or acquired by weather station 108 described with respect to FIG. 1). Environmental data 206 may comprise information associated with precipitation (e.g., rainfall, snow, hail, drizzle, and/or sleet) in a region. For example, environmental data 206 may comprise information associated with an amount and/or timing (e.g., previous times precipitation has occurred in a region) of precipitation in a region. With respect to precipitation, environmental data 206 may comprise information associated with an amount of rainfall in a region and/or rainfall duration in a region. The amount of rainfall may indicate a quantity of rainfall (e.g., an amount in millimeters) in a time interval (e.g., an hour, a day, and/or week). For example, an amount of rainfall that is relatively low (e.g., low relative to an amount of rainfall that is associated with greater proliferation of pathogens and greater disease severity) may be associated with lower disease severity. A predetermined amount of rainfall may be associated with a high predicted disease severity. An amount of rainfall outside a predetermined range (e.g., higher or lower than the predetermined range) may be associated with a low predicted disease severity. For example, the predetermined range for a particular crop genotype may be a rainfall measuring 450-500 mm during the growing season of the crop. That amount of rainfall may be determined to be a range within which predicted disease severity may be high, with a lower amount of rainfall resulting in a lower predicted disease severity.

Environmental data 206 may comprise information associated with a relative humidity in a region. The relative humidity may be expressed as a percentage value that indicates an amount of water vapor in the air at a time interval (e.g., a day or hour of a day). Relative humidity past a relative humidity threshold may be positively correlated with predicted disease severity. For example, a relative humidity greater than 60% may be positively associated with predicted disease severity. A relative humidity less than 30% may be associated with low predicted disease severity.

Environmental data 206 may comprise information associated with a wind speed (e.g., distance per time such as meters per second) in a region. A predetermined range of wind speeds may be positively correlated with predicted disease severity. For example, a wind speed of less than three meters per second may result in less fungicide being blown away, small decreases in drop size if a water occurred in a previous hour, and/or a lower predicted disease severity than when wind speed is greater than three meters per second. In some embodiments, wind speed may be used to determine the longevity of water droplets in consecutive time intervals. Greater windspeed may be associated with a lower longevity of water droplets in consecutive time intervals which may in turn be associated with lower disease severity. Further, environmental data 206 may comprise information associated with wind chill in a region. The wind chill may indicate a lowering of the temperature of a crop due to the passing flow of cooler air. The wind chill may be used to more accurately determine the temperature of a crop.

Environmental data 206 may comprise information associated with temperature in a region. The temperature may indicate an air temperature in degrees Celsius over some time interval (e.g., an hour, a day, or a week). A predetermined range of temperatures may be associated with a greater predicted disease severity than temperatures outside the predetermined range of temperatures. For example, certain temperature ranges may be more conducive to the growth of pathogens on a crop. A temperature outside the predetermined range of temperatures (e.g., higher or lower than the predetermined range of temperatures) may be associated with lower predicted disease severity. The range of temperatures may be based on a combination of the type of crop and the type of disease. Further, different combinations of crops and/or diseases may be associated with different ranges of temperatures result in lower predicted disease severity. The temperature information in environmental data 206 may be used to determine growing degree days for a crop. For example. the mean temperature for a day (e.g., the mean of a high and low temperature for a day) may be compared to a minimum development threshold temperature (e.g., a temperature a crop needs for growth). The number of growing degree days may be positively correlated with the predicted severity of disease and/or the start of an infection interval (e.g., more growing degree days may result in more harm to a crop from a disease).

Environmental data 206 may comprise information associated with dew point in a region. The dew point may indicate an air temperature (at a constant pressure) that may be needed to achieve a relative humidity (e.g., 100% relative humidity) at which dew forms. A temperature lower than or equal to the dew point may be positively correlated with predicted disease severity. Further, environmental data 206 may comprise information associated with dew formation in a crop and may include historical dew formation for a region.

Environmental data 206 may comprise information associated with a barometric pressure for a region. The barometric pressure may indicate a barometric pressure in kilopascals over a time interval (e.g., hours, a day, and/or week). A predetermined range of barometric pressures may be associated with a low predicted disease severity. A barometric pressure outside the predetermined range of barometric pressures may be associated with higher predicted disease severity than disease severity within the range of barometric pressures.

Environmental data 206 may comprise information associated with dew formation, precipitation, irrigation, and/or temperature in the region. For example, environmental data 206 may comprise information associated with the air temperature at which dew has formed on a crop in the past and/or an amount of rainfall associated with the formation of dew on a crop in the past.

Environmental data 206 may comprise information associated with historical weather conditions for a region (e.g., a region in which a crop is grown), a short-term forecast of weather conditions within a short-term time period (e.g., a weather forecast for the next seven days, or the next fifteen days), and/or a long-term forecast (e.g., a weather forecast for the next thirty or sixty days) of weather conditions within a long-term time period comprising a time period subsequent to the short-term time period. For example, environmental data 206 may comprise air temperature forecasts for the next ten days. Further, a weather forecast may comprise a plurality of predicted humidities for the plurality of time periods (e.g., hourly humidity for a seven day period), a plurality of predicted rainfalls for the plurality of time periods (e.g., daily and/or hourly rainfall for a seven day period), and/or a plurality of predicted temperatures (e.g., daily and/or hourly mean temperature for a seven day period) for the plurality of time intervals.

Input 202 may comprise agronomic data 208 which may comprise information associated with agronomic practices (e.g., tillage practices, crop history, and/or fertilization history) for a crop in a region. With respect to tillage practices, agronomic data 208 may comprise information associated with the preparation of soil for planting and/or cultivation after planting. The agronomic data 208 may indicate the types of devices that are used to till soil (e.g., ploughs, rototillers, and/or cultivators) and/or indications of the type and timing of primary tillage and secondary tillage.

Agronomic data 208 may comprise information associated with a crop history in a region. The crop history may indicate previous actions that were performed on crops in a region. For example, the crop history may indicate a crop rotation history of a crop, intervals during which a region in which a crop may be grown was left fallow, and/or intervals when crops in a region were harvested. Further, crop history may comprise information associated with yields from previous harvests of a crop in a region and crop residue left over from a previous year. The agronomic data 208 may also comprise a planting date of a crop, a planting rate of the crop, field residue data for a crop that overwinters and carries into a subsequent year, and/or a planting density of the crop.

Agronomic data 208 may comprise information associated with a fertilization history for a crop in a region. The fertilization history may indicate previous actions associated with fertilization that were performed on a crop in a region. Further, the fertilization history may indicate time intervals at which a crop was fertilized and/or a type and/or amount of fertilizer that was applied to a crop in the past. The agronomic data 208 may also include information associated with a fertilizer (e.g., nitrogen fertilizer) amount per square meter of a region.

Agronomic data 208 may comprise information associated with irrigation practice that were performed on a crop in a region. Further, the irrigation practice may indicate time intervals at which a crop was irrigated, a duration of irrigating a crop in the past, and/or an amount of water that was used to irrigate a crop in the past. The irrigation practice may also indicate the way in which a crop may be irrigated including sub-irrigation, drip irrigation, sprinkler irrigation, surface irrigation, and/or manual irrigation.

Input 202 may comprise crop genotype data 210 which may comprise information associated with the genotype of a crop in a region. Crop genotype data 210 may indicate the unique genetic sequence (e.g., DNA sequence) associated with a particular type of crop in a region. Crop genotype data 210 may be associated with information indicating various traits of a crop including a crop's response to abiotic stress and/or abiotic stress. Crop genotype data 210 may include information associated with the way in which a particular genotype of crop responds to various environmental conditions, soil conditions, and/or agronomy practices. For example, certain genotypes of crop may respond differently to different temperatures, humidities, soil conditions, and/or crop rotation practices. Accordingly, the effects of those conditions or practices may vary depending on crop genotype.

Crop genotype data 210 may comprise information associated with one or more disease tolerance scores that indicate a resistance of a crop to one or more pathogens. For example, a disease tolerance score may range from zero (e.g., low resistance to a disease) to one hundred (e.g., high tolerance to a disease). Further, a crop with a disease tolerance score of ninety five for gray leaf spot may indicate a high tolerance of the crop to gray leaf spot.

One or more machine learning models 212 may be configured and/or trained to determine predicted disease severity 214. Determination of predicted disease severity 214 may be based on one or more machine learning models 212 receiving input 202 comprising soil data 204, environmental data 206, agronomic data 208, and/or crop genotype data 210; processing input 202; and generating output comprising predicted disease severity 214. Predicted disease severity 214 may comprise an indication of negative impacts and/or adverse costs (e.g., reduced yield, crop damage, and/or crop spoilage) that may result from a disease and/or pathogen that causes harm to a crop. Predicted disease severity 214 may be expressed as one or more numeric values that may indicate the magnitude of predicted disease severity. For example, predicted disease severity 214 may comprise a predicted disease severity score corresponding to a single time interval (e.g., a time interval at which to initiate spraying a crop) or a plurality of disease severity scores corresponding to a plurality of time intervals. Further, the plurality of disease severity scores may range from zero to one hundred with a score of zero being associated with a lowest disease severity, a score of one hundred being associated with a highest disease severity, and intermediate scores between zero and one hundred being associated with varying magnitudes of intermediate disease severity (e.g., a disease severity score of fifty may be associated with a disease severity that is less severe than a disease severity score of eighty and more severe than a disease severity score of twenty). The predicted disease severity 214 may comprise a plurality of values and a corresponding plurality of time intervals. For example, predicted disease severity may comprise thirty values associated with successive days. The thirty values associate with successive days may be associated with corresponding predicted disease severity values ranging from zero (e.g., least severe) to one hundred (e.g., most severe).

One or more machine learning models 212 may be configured and/or trained to analyze inputs (e.g., input 202) and generate a predicted disease severity based on the inputs. One or more machine learning models 212 may, for example, comprise one or more neural networks (e.g., one or more recurrent neural networks (RNNs), one or more multi-layer perceptrons (MLPs), and/or one or more convolutional neural networks (CNNs)), one or more random forest models, one or more support vector machines (SVMs), and/or a Bayesian hierarchical model. The term machine learning model may be construed as meaning one or more machine learning models any of which may operate singularly or in combination with one or more other machine learning models to perform the operations described herein.

Further, one or more machine learning models 212 may be configured and/or trained using various training techniques including supervised learning, unsupervised learning, semi-supervised learning, and/or reinforcement learning. One or more machine learning models 212 may, for example, comprise parameters that have adjustable weights and fixed biases. As part of the process of configuring and/or training one or more machine learning models 212, values associated with each of the weights of the one or more machine learning models 212 may be modified based on the extent to which each of the parameters contributes to increasing or decreasing the accuracy of output generated by the one or more machine learning models 212. For example, parameters of one or more machine learning models 212 may correspond to various features of inputs (e.g., inputs based on soil features, genotype features, environmental features, and/or agronomic features associated with crops in a region). Over a plurality of iterations, and based on inputting training data to one or more machine learning models 212, the weighting of each of the parameters may be adjusted based on the extent to which each of the parameters contributes to accurately determining predicted disease severity at sample locations.

Training one or more machine learning models 212 may comprise the use of a cost function that may be used to minimize the error between output of the one or more machine learning models 212 and a ground-truth value. For example, one or more machine learning models 212 may receive input comprising training data comprising soil data, environmental data, agronomic data, and/or genotype data similar to soil data 204, environmental data 206, agronomic data 208, and/or crop genotype data 210 described herein. The training data may be based on recorded disease severity for a crop that was previously planted and harvested. Accurate output by one or more machine learning models 212 may include determining a predicted disease severity that matches or is very similar to (e.g., within a predetermined range of similarity) the ground-truth disease severity. Inaccurate output by one or more machine learning models 212 may include determining a predicted disease severity that does not match and/or is very dissimilar to (e.g., outside of a predetermined range of similarity) the ground-truth disease severity. Over a plurality of training iterations, the weighting of the parameters of one or more machine learning models 212 may adjusted until the accuracy of the machine learning model's output reaches some threshold accuracy level (e.g., 99% accuracy). Further, output of one or more machine learning models 212 may comprise one or more scores associated with the predicted disease severity.

Predicted disease severity 214 may be inversely correlated with the one or more disease tolerance scores of the crop. For example, a crop with a high disease tolerance score (e.g., a score of ninety five on a scale of zero to one hundred) may have a lower predicted disease severity than a crop with a low disease tolerance score (e.g., a score of ten on a scale of zero to one hundred). Each of the one or more pathogens may be associated with a temperature range and/or a humidity range that increase the predicted disease severity for the crop (e.g., corn). For example, the predicted disease severity resulting from a tar spot pathogen may increase or decrease based on whether the temperature and/or humidity are within a range that increases or decreases the severity of the effects of the tar spot pathogen. One or more machine learning models 212 may be configured to determine a risk of a crop (e.g., corn) being infected by one or more pathogens and the risk of a crop being infected by one or more pathogens may be positively correlated with predicted disease severity.

One or more machine learning models 212 may comprise a leaf wetness model that may be used to determine leaf wetness for a crop (e.g. corn) in the region based on environmental data 206. The leaf wetness of the crop may be positively correlated with the predicted disease severity of the crop. For example, one or more machine learning models 212 may use a leaf wetness model to determine that leaf wetness and/or a certain dewpoint may be positively associated with the growth of fungus and/or mold that increase predicted disease severity in a crop. Further, one or more machine learning models 212 may use a leaf wetness model to determine that leaf wetness of certain crops (e.g., corn) may be positively correlated with the predicted disease severity of the crop. For example, one or more machine learning models 212 may receive information that indicates a proportion of the leaves of a crop (e.g., corn) that are covered in foliar lesions. Further, one or more machine learning models 212 may determine that the predicted disease severity may be positively correlated with a proportion of leaves of the crop that are predicted to be covered in foliar lesions.

One or more machine learning models 212 be configured and/or trained to determine one or more times at which dew or rain droplets are predicted to form or persist on leaves of a crop. The determination of the one or more times at which dew or rain droplets are predicted to form or persist on leaves of a crop may be based on inputting (e.g., from environmental data 206) a plurality of predicted humidities and the plurality of predicted temperatures for the plurality of time intervals into the one or more machine learning models. The formation and/or persistence of dew on the leaves of a crop may be positively correlated with the predicted disease severity. For example, a greater number of times that leaves of a crop are wet (e.g., due to dew or rain droplets) and/or a longer duration of leaves of a crop being wet may result in a greater predicted disease severity. Leaves of a crop that do not get wet may result in a lesser predicted disease severity.

Further, one or more machine learning models 212 may be configured and/or trained to determine a predicted disease severity for one or more diseases comprising northern corn leaf blight, gray leaf spot, tar spot, black spot, and/or ergot. One or more machine learning models 212 may also be configured and/or trained to determine a predicted disease severity for a crop in a region. Predicted disease severity 214 may be associated with one or more biotic and/or one or more abiotic factors.

Predicted disease severity 214 may be associated with a plurality of disease severity scores that may be positively correlated with disease severity. For example, the plurality of predicted disease severity scores may be associated with a predicted proportion of crops that may be afflicted by a pathogen, a proportion of crops that are predicted to succumb to a pathogen, and/or a severity of harm caused to a sampling of crops (e.g., a sampling that may represent the average state of crops in a region) by a pathogen. Further, each of the plurality of predicted disease severity scores may be associated with a corresponding plurality of threshold sensitivities or the plurality of predicted severity scores may be combined and compared to a single threshold sensitivity. The predicted disease severity meeting the one or more criteria may be based on at least one of the plurality of disease severity scores exceeding the sensitivity threshold. For example, if three disease severity scores have been generated and none of the three disease severity scores meet their respective sensitivity threshold, the one or more criteria may be determined not to have been met. By way of further example, if three disease severity scores have been generated and one of the three disease severity scores meets its respective sensitivity threshold, then the one or more criteria may be determined to have been met.

Predicted disease severity 214 may comprise predicted disease severity in a plurality of sub-regions. For example, a region in which crops are grown may comprise four sub-regions that may be distant from one another (e.g., regions that are five kilometers apart). As a result of the distance between the sub-regions, the soil conditions, environmental conditions, and/or agronomic practices in the sub-regions may be different. One or more machine learning models 212 may determine a different predicted disease severity for each of the four sub-regions and each of the different predicted severities may also have its own fungicide timing schedule.

After predicted disease severity 214 has been generated by one or more machine learning models 212, the sensitivity threshold operations 216 may be used to determine whether the predicted disease severity 214 meets one or more criteria. For example, predicted disease severity 214 may be a numerical value (e.g., a score) that may be compared to a sensitivity threshold. The extent to which predicted disease severity meets or exceeds a sensitivity threshold may be used in determining a plurality of time intervals of a fungicide timing schedule (e.g., the ranges of days and/or hours at which fungicide may be sprayed onto crops in a region).

Based on predicted disease severity 214 meeting one or more criteria (e.g., a predicted disease severity score associated with predicted disease severity 214 exceeds a sensitivity threshold), spray timing schedule 218 (e.g., a fungicide timing schedule) may be generated. Spray timing schedule 218 may comprise information associated with a plurality of time intervals at which to apply (e.g., spray) fungicide and/or other substances (e.g., water and/or pesticide) onto crops in a region. For example, the spray timing schedule 218 may comprise a list of dates and corresponding indications of which dates to spray fungicide and/or other substances onto the crops and which dates not to spray fungicide and/or other substances onto crops. For example, spray timing schedule 218 may indicate that spraying of fungicide may begin on the fifth of May at any time of day and until fungicide has been applied to crops in a region. By way of further example, timing schedule 218 may indicate that spraying of fungicide may begin on February fifth at a particular time of day (e.g., eight o'clock in the morning) until fungicide has been applied to crops in a region. The spray timing schedule 218 may also indicate that fungicide may be applied to crops in the region for an additional three days after application of fungicide has been initiated. Further, the spray timing schedule 218 may indicate a first day on which to initiate spraying fungicide and/or other substances onto crops, a time interval between the application of fungicide and/or other substances, and/or a last day on which to spray fungicide and/or other substances onto crops.

The fungicide may comprise two or more types of fungicide and the fungicide timing schedule may comprise a recommendation of an amount of the two or more types of fungicide to spray onto the crop. For example, the fungicide may comprise two different formulations of fungicide and the fungicide timing schedule may comprise an indication of which fungicide or combination of fungicides to apply to crops on each of the time intervals (e.g., days or hours) on the spray timing schedule 218. Spray timing schedule 218 may be based in part on a weather forecast indicated in environmental data 206. For example, if environmental data 206 indicates that there will be heavy rainfall on a particular day, the spray timing schedule 218 may be generated so that application of fungicide to crops begins before or after the heavy rainfall with enough time to allow the fungicide to be effective (e.g., not washed away).

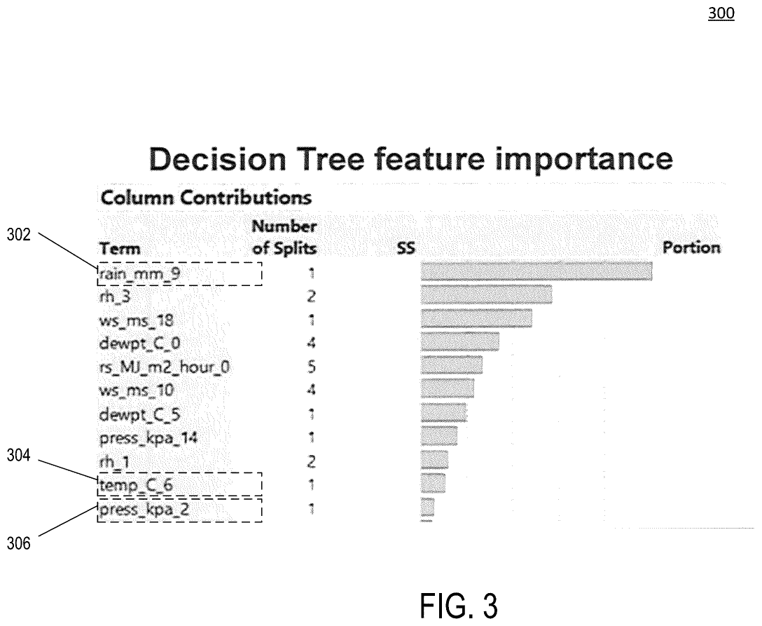

FIG. 3 shows an example of decision tree feature importance according to one or more aspects of the disclosure. The decision tree feature importance shown in FIG. 3 may be used by the systems and devices described herein including the computing system 100 shown in FIG. 1.

The diagram 300 comprises an indication of the relative importance of various environmental features that may be included in environmental data (e.g., environmental data 206). The environmental features may be used in various ways including as input to a machine learning model that may be used to generate disease severity predictions and/or fungicide spraying schedules and/or as input used to train a machine learning model to generate disease severity predictions and/or fungicide spraying schedules. Further, a machine learning model (e.g., one or more machine learning models 212) may comprise a decision tree and the environmental features shown in FIG. 3 may be associated with nodes (e.g., nodes that may correspond to parameters of a machine learning model) of the decision tree. The weighting of the nodes of the decision tree may be based in part on the extent to which the features associated with the nodes of the decision tree accurately predict disease severity in a crop. For example, the rainfall feature 302 of a decision tree that makes a greater contribution to accurately predicting disease severity may be more heavily weighted in the decision tree than other features (e.g., temperature feature 304) that contribute less to predicting disease severity. By way of further example, the features (e.g., barometric pressure feature 306) of the decision tree makes a lesser contribution to accurately predicting disease severity in a crop and may be less heavily weighted in a decision tree.

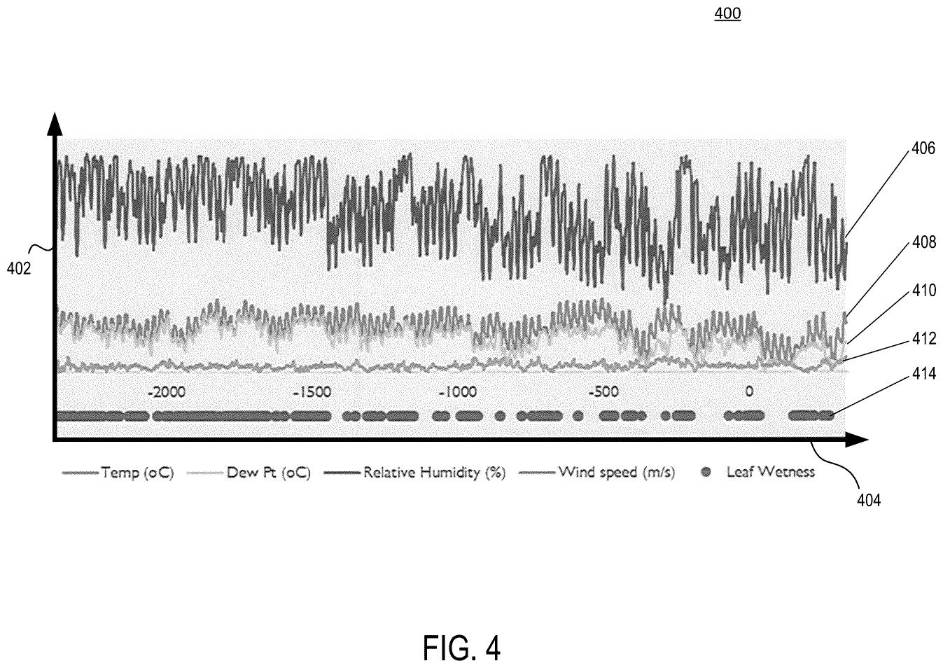

FIG. 4 shows relationships between leaf wetness and features of environmental data according to one or more aspects of the disclosure. The relationships between leaf wetness and features of environmental data may be used by the systems and devices described herein including the computing system 100 shown in FIG. 1.

FIG. 4 shows a diagram 400 that indicates environmental conditions that are associated with leaf wetness. The environmental conditions associated with leaf wetness indicated in the diagram 400 include relative humidity 406, temperature 408, dew point 410, and wind speed 412. The axis 402 indicates a magnitude of relative humidity 406, temperature 408, dew point 410, or wind speed 412. The axis 404 is a timeline that may be associated with a relative humidity 406, temperature 408, dew point 410, or wind speed 412 at a given point in time. For many fungal diseases, a spore may need to germinate on a leaf of the crop in order to penetrate the leaf and infest the plant. Spore germination may rely on water, and leaf wetness may be positively correlated with the outbreak of many types of fungal diseases. As shown in FIG. 4, different environmental conditions may contribute to leaf wetness. For example, relative humidity 406 appears to be more highly correlated with leaf wetness than wind speed 412. The environmental data (e.g., environmental data 206) may include one or more of the environmental conditions indicated in the diagram 400. Further, the one or more machine learning models described herein (e.g., one or more machine learning models 212) may use environmental data based on the environmental conditions as an input that may be processed to generate a predicted disease severity.

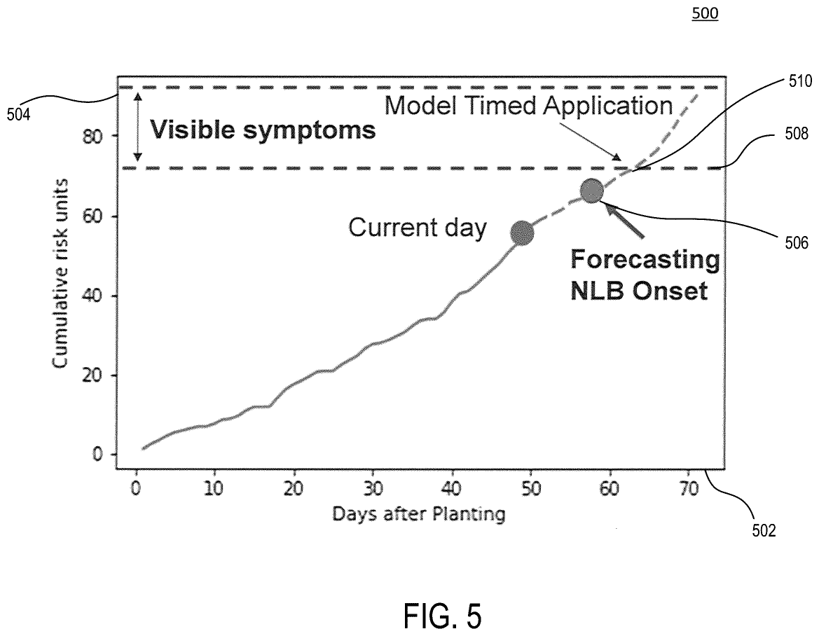

FIG. 5 shows cumulative risk of crop disease over time according to one or more aspects of the disclosure. The cumulative risk of crop disease over time may be used by the systems and devices described herein including the computing system 100 shown in FIG. 1.

FIG. 5 shows a diagram 500 that includes an axis 502 that indicates a number of days after a crop was planted, and an axis 504 that indicates a cumulative risk of disease in a crop. The cumulative risk indicated by the axis 504 may be positively correlated with the risk of a crop becoming infested with a disease (e.g., northern leaf blight). In this example, a machine learning model (e.g., one or more machine learning models 212 described with respect to FIG. 2) has determined that the onset of northern leaf blight is predicted to occur at the time 506 (e.g., the fifty eighth day after planting the crop) with visible symptoms occurring at time 508. Further, the machine learning model has generated a fungicide spraying schedule that indicates that the application of fungicide to the crop should be performed at the time 510 (e.g., the sixty second day after planting the crop). The timing of the application of fungicide to the crop at time 510 may mitigate the harmful effects of disease.

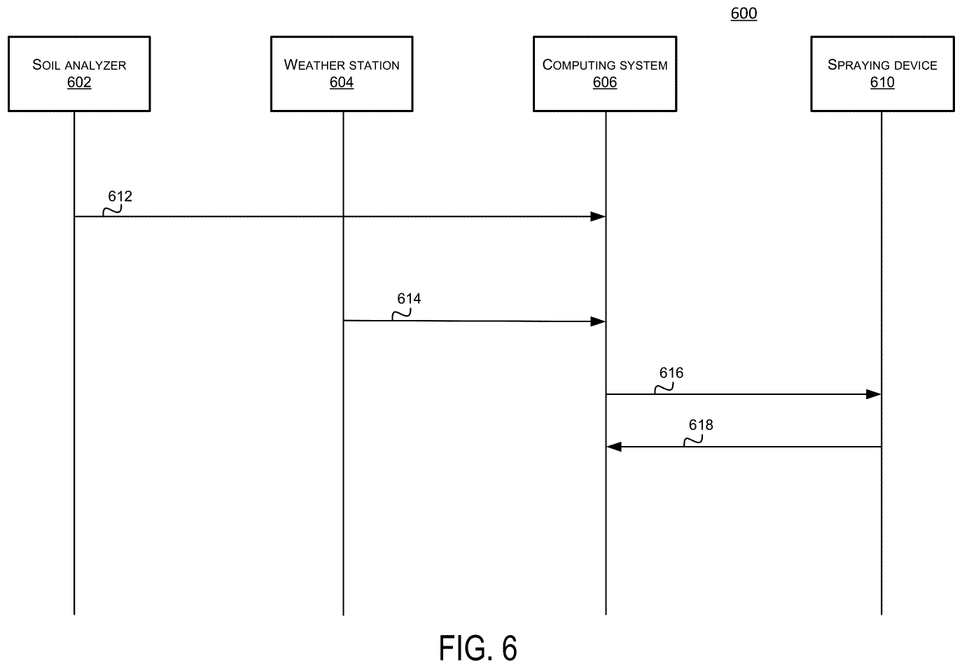

FIG. 6 shows a timing diagram that indicates a data flow of signals associated with generating and implementing a fungicide spray timing schedule according to one or more aspects of the disclosure. Computing devices and/or systems associated with data flow 600 may include any of the features and/or components of computing system 104, soil analyzer 106, weather station 108, and/or spraying device 110, which are shown in FIG. 1. Further, the operations performed as part of the data flow 600 may be performed by the computing systems and/or computing devices that are described herein.

Soil analyzer 602 (e.g., the soil analyzer 106 described with respect to FIG. 1) may gather samples of soil and generate soil data (e.g., soil data 204). Further, soil analyzer 602 may be configured to access soil data stored in a soil database (e.g., soil survey geographic database (SSURGO)). Soil analyzer 602 may send signal 612 comprising the soil data to computing system 606.

Weather station 604 (e.g., the weather station 108 described with respect to FIG. 1) may be a weather station that may be operated by an entity associated with applying fungicide to a crop and/or a third-party entity (e.g., a private organization or governmental agency that provides environmental data which may comprise weather information and/or a weather forecast). Weather station 604 may generate environmental data (e.g., environmental data 206). Further, weather station may send a signal 614 that includes the environmental data to computing system 606.

Computing system 606 may be configured to receive the signal 612 and/or the signal 614. In some embodiments, computing system 606 may be configured to send signals comprising a request for soil data to soil analyzer 602 and/or a request for environmental data to weather station 604. Soil analyzer 602 may be configured to send signals comprising soil data to computing system 606 in response to the signals requesting soil data sent by computing system 606. Weather station 604 may be configured to send signals comprising environmental data to computing system 606 in response to the signals requesting environmental data sent by computing system 606. In this example, computing system 606 may generate a predicted disease severity based on the signals 612 and 614 as well as additional agronomic data and/or genotype data that may be accessible by computing system 606. Further, computing system 606 may generate a spray timing schedule (e.g., a fungicide timing schedule) based on the predicted disease severity. Computing system 606 may send a signal 616 (e.g., a signal including a fungicide timing schedule) to spraying device 610.

Spraying device 610 may in turn send a signal 618 (e.g., a signal confirming receipt of the spray timing schedule (e.g., fungicide timing schedule) in the signal 616) to computing system 606. Spraying device 610 may use instructions included in the signal 616 to apply fungicide onto crops. For example, spraying device 610 may be an underground irrigation device that may apply specified amounts of a certain type of fungicide at certain times of day on days indicated in the fungicide timing schedule.

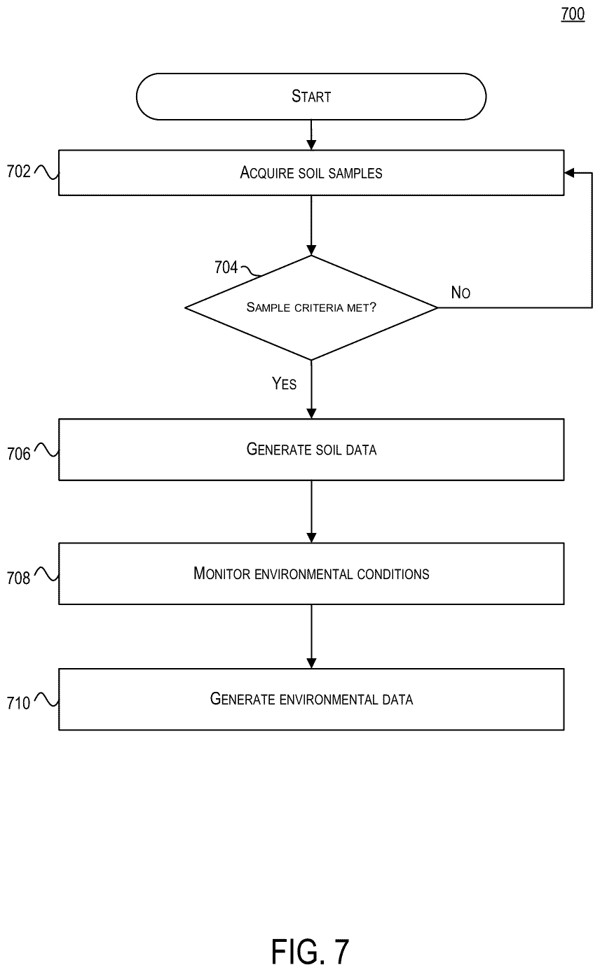

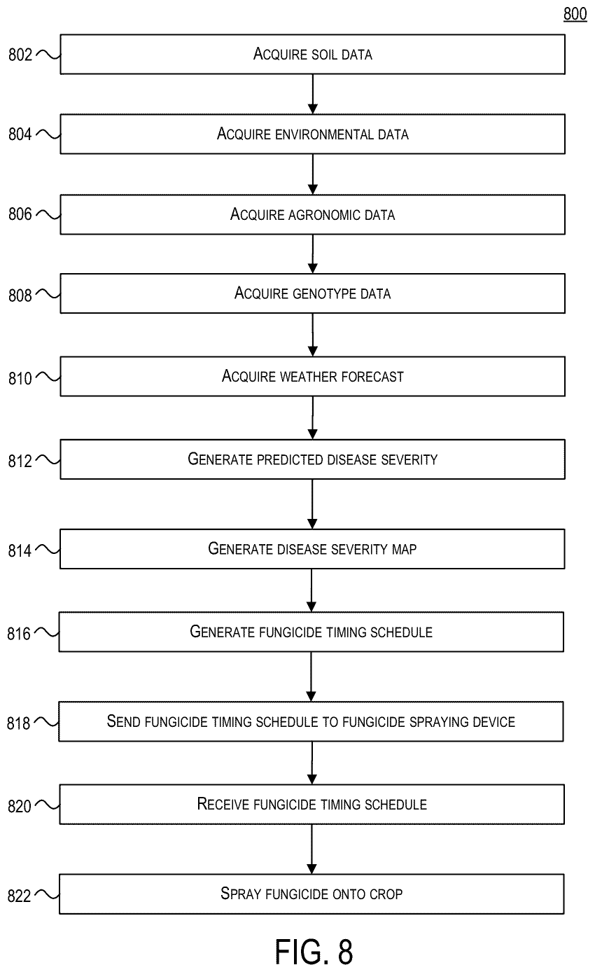

FIG. 7 shows an example flow chart for automated generation of a fungicide timing schedule according to one or more aspects of the disclosure. One or more aspects of the disclosure may be implemented by the devices described herein (e.g., the computing system 100 shown in FIG. 1). One or more of the steps described with respect to FIG. 7 may be omitted, performed in a different order, and/or modified. Further, one or more additional steps (e.g., the steps described with respect to FIGS. 8 and/or 9) may be added to the steps described with respect to FIG. 7.

At step 702, samples of soil may be acquired. The samples of soil may be acquired from a region comprising a crop (e.g., corn). For example, a soil analyzer (e.g., the soil analyzer 106 described with respect to FIG. 1) may acquire samples of soil from the ground of a region in which a crop is grown. Further, the samples of soil may be sampled from one or more sub-regions of the region.

At step 704, there may be a determination of whether one or more sample criteria have been met. The one or more sample criteria may comprise a threshold number of samples having been acquired, a threshold volume of samples of soil having been acquired, samples of soil having been acquired on a threshold number of different days, and/or samples of soil having been acquired from a threshold number of sub-regions of a region. Based on the one or more sample criteria being met soil data may be generated in step 706. Based on the one or more sample criteria not being met, more samples of soil may be acquired in step 702.

At step 706, soil data may be generated. The soil data may be generated based on the samples of soil. For example, various features and/or characteristics of samples of soil may be determined using one or more devices including a soil analyzer (e.g., soil analyzer 106 described with respect to FIG. 1). Further, the soil data may comprise information associated with a location and/or time at which a soil sample was acquired. The soil data may comprise the information and/or features described in soil data 118 and/or soil data 204.

At step 708, environmental conditions may be monitored. The environmental data may be based on the monitoring of environmental conditions within a region comprising a crop. The environmental conditions in a region may comprise air temperature, wind speed, wind direction, humidity, and/or precipitation (e.g., rainfall). For example, a weather station (e.g., the weather station 108 described with respect to FIG. 1) may monitor environmental conditions in a region using one or more sensors.

At step 710, environmental data may be generated. The environmental data may be generated based on the environmental conditions that were monitored. For example, a weather station (e.g., the weather station 108 described with respect to FIG. 1) may generate environmental data based on environmental conditions of a region that were monitored by the weather station. The environmental data may comprise environmental conditions within a region comprising the crop, historical environmental conditions within the region comprising the crop, and/or forecasted environmental conditions within the region comprising the crop. Further, the environmental data may comprise the information described in environmental data 120 and/or environmental data 206.

FIG. 8 shows an example flow chart for automated generation of a fungicide timing schedule according to one or more aspects of the disclosure. One or more aspects of the disclosure may be implemented by the devices described herein (e.g., the computing system 100 shown in FIG. 1). One or more of the steps described with respect to FIG. 8 may be omitted, performed in a different order, and/or modified. Further, one or more additional steps (e.g., the steps described with respect to FIGS. 7 and/or 9) may be added to the steps described with respect to FIG. 8.

At step 802, soil data may be acquired. Soil data may be based on samples of soil from a region comprising a crop (e.g., corn). For example, a computing system (e.g., computing system 104) may acquire soil data from a soil analyzer (e.g., the soil analyzer 106 described with respect to FIG. 1) via a network (e.g., the network 102). Further, the soil data may comprise the information and/or features described in soil data 118 and/or soil data 204. For example, the soil data may include information associated with a pH and/or an organic matter percentage of soil collected from a region in which a crop is being grown.

At step 804, environmental data may be acquired. Environmental data may be based on environmental conditions within the region comprising the crop. For example, a computing system (e.g., computing system 104) may acquire environmental data from a weather station (e.g., the weather station 108 described with respect to FIG. 1) via a network (e.g., the network 102). Further, the environmental data may comprise the information described in environmental data 120 and/or environmental data 206. For example, the environmental data may include information associated with a temperature and/or rainfall in a region in which a crop is being grown.

At step 806, agronomic data may be acquired. The agronomic data may comprise information associated with a tillage practice, a crop history, and/or a fertilization history. For example, a computing system (e.g., computing system 104) may acquire agronomic data from another computing system or computing device (e.g., a computing system used by a manager of the region in which a crop is grown) via a network (e.g., the network 102). Further, the agronomic data may comprise the information described in agronomic data 122 and/or agronomic data 208. For example, the agronomic data may include information associated with a crop rotation schedule for a crop.

At step 808, crop genotype data may be acquired. Crop genotype data may comprise a genotype and/or pathogen resistance characteristics of the crop. For example, a computing system (e.g., computing system 104) may acquire genotype data from another computing system or computing device (e.g., a computing system used by a manager of the region in which a crop is grown) via a network (e.g., the network 102). Further, the genotype data may comprise the information described in crop genotype data 124 and/or crop genotype data 210. For example, the genotype data may include information associated with the genotype of a crop and the extent to which a crop may be resistant to a particular disease.

At step 810, a weather forecast may be acquired or determined. Acquiring a weather forecast may comprise accessing environmental data that includes a weather forecast from a source of weather forecast information (e.g., the National Digital Forecast Database (NDFD)). Acquisition or determination of the weather forecast may be based on environmental data. For example, as described herein, environmental data may comprise one or more weather forecasts for a region Further, the weather forecast may be for a region comprising the crop. For example, a computing system (e.g., computing system 104) may determine a weather forecast based on environmental data. The weather forecast may comprise predicted weather conditions over a plurality of time intervals (e.g., days or hours). For example, the weather forecast may indicate predictions of an amount of rainfall and/or temperature in a region in each hour over a period of two weeks.

At step 812, a predicted disease severity for the crop in the region over a plurality of time intervals may be generated. The predicted disease severity may be based on inputting the weather forecast, the soil data, the agronomic data, and/or the crop genotype data into one or more machine learning models. The one or more machine-learning models (e.g., one or more machine learning models 212 described with respect to FIG. 2) may be configured and/or trained to determine and/or generate a predicted disease severity based on input comprising the weather forecast, the soil data, the agronomic data, and/or the crop genotype data. The predicted disease severity may comprise a score (e.g., a numerical score) that may be positively correlated with disease severity. For example, predicted severity may range from zero to one hundred with a score of zero being associated with the lowest disease severity and a score of one hundred being associated with the highest disease severity.

In some embodiments, the predicted disease severity may be based on processing the weather forecast, the soil data, the agronomic data, and/or the crop genotype data. For example, the weather forecast, the soil data, the agronomic data, and/or the crop genotype data may be used as inputs to a predicted disease severity algorithm that performs operations on the inputs and outputs the predicted disease severity. Some inputs may be weighted based on the genotype data. For example, the genotype of a crop may be used to determine the relative weighting of the weather forecast, the soil data, and/or the agronomic data, which may then be used to determine a predicted disease severity.

At step 814, a disease severity map for the region may be generated. A disease severity map comprise a plurality of indications of the predicted disease severity in each of a plurality of sub-regions of the region. For example, a computing system (e.g., computing system 104) may generate a disease severity map that indicates predicted disease severity in a plurality of sub-regions of a geographic region.

At step 816, a spray timing schedule may be generated. For example, a fungicide timing schedule may be generated. The spray timing schedule (e.g., fungicide timing schedule) may be based on the predicted disease severity and/or a sensitivity threshold. The spray timing schedule (e.g., fungicide timing schedule) may comprise a plurality of time intervals at which to spray fungicide and/or other substances onto the crop. The sensitivity threshold may be associated with the predicted disease severity at which spraying the fungicide and/or other substances onto the crop may be initiated. Further, the sensitivity threshold may be associated with a sensitivity to the risk of disease in a crop (e.g., an amount of disease risk that may be tolerated before spraying fungicide onto a crop is initiated). For example, a relatively higher sensitivity threshold may result in the generation of a fungicide timing schedule that initiates spraying of fungicide at a time interval associated with a higher disease severity that occurs at a later time interval. By way of further example, a relatively lower sensitivity threshold may result in the generation of a fungicide timing schedule that initiates spraying of fungicide at a time interval associated with a lower disease severity that occurs at an earlier time interval. The sensitivity threshold may be a default value or have some preset configuration. For example, a sensitivity threshold may be a preset value that is configured without user input.

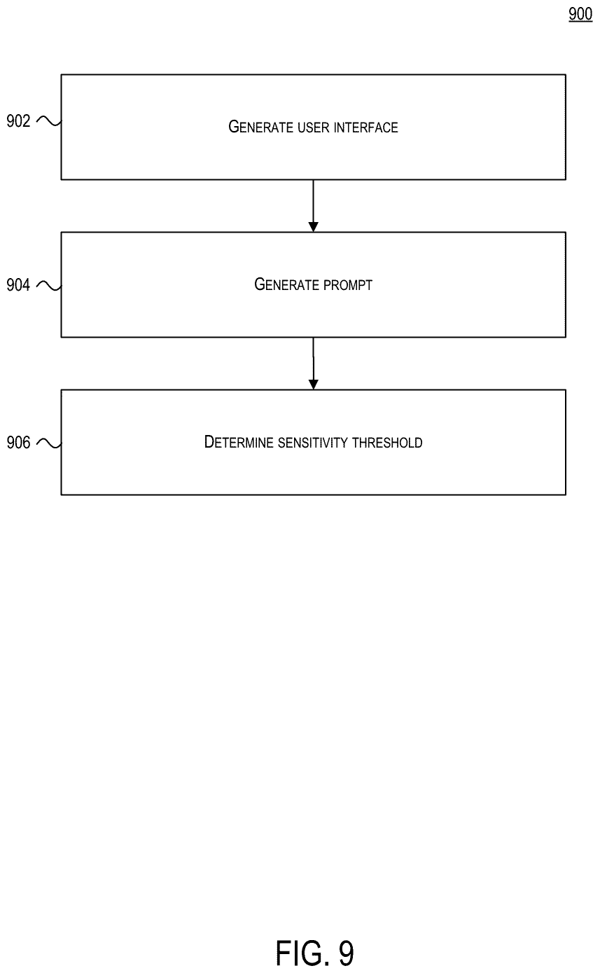

In some embodiments, a sensitivity threshold may be based on a selection or determination (e.g., via a user interface) by a user of the disclosed technology as described in steps 902-906 with respect to FIG. 9. A sensitivity threshold selected or determined by a user allows a user to adjust the threshold sensitivity based on a user's preferences (e.g., a user's tolerance for the risk of disease in a crop). The spray timing schedule (e.g., fungicide timing schedule) may comprise a plurality of time intervals at which to spray two or more types of fungicide and/or other substances onto a crop. For example, one type of fungicide may be sprayed onto crops at some of the plurality of time intervals and a different type of fungicide may be sprayed onto crops at a different plurality of time intervals. In some embodiments, some of the plurality of time intervals may comprise a combination of different types of fungicide. Further, the spray timing schedule (e.g., fungicide timing schedule) may comprise a plurality of time intervals at which to spray one or more amounts of fungicide onto a crop. For example, one amount of fungicide may be sprayed onto crops at some of the plurality of time intervals and a different amount of fungicide may be sprayed onto crops at a different plurality of time intervals. Further, the spray timing schedule may comprise the information and/or features described in spray timing schedule 126 and/or spray timing schedule 218. Following the generation of a spray timing schedule (e.g., a fungicide timing schedule) various operations may be performed. For example, the spray timing schedule (e.g., fungicide timing schedule) may be sent to a fungicide spraying device as described in step 818. In some embodiments, the spray timing schedule may be generated then accessed by a device that may use the spray timing schedule as instructions that may be implemented or otherwise used by one or more devices associated with the application of fungicide and/or other substances and/or as a recommendation that may be used to determine a type and/or an amount of fungicide and/or other substances to spray onto crops. For example, the spray timing schedule may include instructions that may be used by different devices (e.g., different types of fungicide spraying devices) that are used to spray crops in a region.

At step 818, a spray timing schedule may be sent to a spraying device. For example, a fungicide timing schedule may be sent to a spraying device (e.g., a fungicide spraying device). Sending the spray timing schedule to the spraying device may be based on the predicted disease severity meeting one or more criteria. For example, a computing system (e.g., computing system 104 described with respect to FIG. 1) may send wireless signals to a fungicide spraying device (e.g., the spraying device 110 described with respect to FIG. 1) via a network (e.g., the network 102). Further, the fungicide spraying device may be configured to spray two or more types of fungicide onto the crop.

At step 820, a spraying device may receive the spray timing schedule. For example, a fungicide spraying device may receive a fungicide timing schedule. For example, a fungicide spraying device (e.g., the spraying device 110 described with respect to FIG. 1) may comprise a wireless receiver that is configured to receive signals comprising a fungicide timing schedule. In some examples, the step of receiving the fungicide timing schedule may include changing/updating an existing timing schedule to a new timing schedule such that it causes the spraying device 110 to alter its behavior. For example, the device may trigger and spray more frequently over time, less frequently over time, or in some other way due to the changes received via the wireless receiver. While the preceding example references a spraying device 110, the disclosure is not so limited, and the received changes may modify the behavior/operation of one or more other devices communicatively coupled to the wireless receiver.

At step 822, a spraying device may spray fungicide, water, and/or pesticide onto a crop based on a spray timing schedule. For example, a fungicide spraying device) may spray fungicide onto a crop based on the fungicide timing schedule. For example, a fungicide spraying device (e.g., the spraying device 110 described with respect to FIG. 1) may process the fungicide timing schedule and spray a crop based at a plurality of times indicated in the fungicide timing schedule.

FIG. 9 shows an example flow chart for automated generation of a fungicide timing schedule according to one or more aspects of the disclosure. One or more aspects of the disclosure may be implemented by the devices described herein (e.g., the system 100 shown in FIG. 1). One or more of the steps described with respect to FIG. 9 may be omitted, performed in a different order, and/or modified. Further, one or more additional steps (e.g., the steps described with respect to FIGS. 7 and/or 8) may be added to the steps described with respect to FIG. 9.

At step 902, a user interface may be generated. The user interface may comprise a plurality of interface elements corresponding to a plurality of descriptions of the predicted disease severity. Further, the plurality of descriptions may comprise a plurality of values associated with disease severity in the crop. For example, the user interface may comprise a graphical user interface that may receive input via a touch screen or a pointing device (e.g., mouse or stylus) that may be used to select one of the plurality of interface elements. The plurality of interface elements may comprise an interface element that may be an adjustable slider that may be used to select a sensitivity threshold associated with a predicted disease severity score ranging from zero to one hundred. For example, a predicted disease severity of ten may be associated with a low sensitivity (e.g., there may be a longer waiting period before fungicide is applied onto a crop) and a sensitivity threshold of ninety may be associated with a high sensitivity threshold (e.g., there may be less time before fungicide is applied onto a crop). In some embodiments, as described in step 816 with respect to FIG. 9, a sensitivity threshold may be a predetermined value and may be used without user input (e.g., selecting an interface element of a user interface).

At step 904, a prompt may be generated in the user interface. The prompt may request an input to select one of the plurality of interface elements that indicates a predicted disease severity at which to spray the fungicide onto the crop. For example, the prompt may indicate “PLEASE SELECT A SENSITIVITY THRESHOLD BY ADJUSTING THE PREDICTED DISEASE SEVERITY INDICATOR.” An input to the predicted disease severity indicator may be used to adjust a sensitivity threshold.

At step 906, a sensitivity threshold may be determined. Determination of the sensitivity threshold may be based on the input. For example, if a sensitivity threshold corresponding to a predicted disease severity score of ten was selected, then a sensitivity threshold of ten may be used when generating a fungicide timing schedule.

The system and method described above for providing an automated fungicide spray timing is particularly efficacious when used with a combination of two fungicides. The timing provided by the method described provides a consistent yield advantage when compared with the standard spray timings currently employed, based on scouting or the farmer's past experience.

A wide range of two-or three-way combinations of fungicides may be employed using this method to achieve a yield advantage. The fungicides may be selected from a list containing butylamine, cymoxanil, dodicin, dodine, guazatine, iminoctadine, xinjunan, carpropamid, chloraniformethan, cyflufenamid, diclocymet, diclocymet, dimoxystrobin, fenaminstrobin, fenoxanil, flumetover, isofetamid, mandestrobin, mandipropamid, metominostrobin, orysastrobin, prochloraz, quinazamid, silthiofam, triforine, trimorphamide, benalaxyl, benalaxyl-M, furalaxyl, metalaxyl, metalaxyl-M, pefurazoate, valifenalate, boscalid, carboxin, fenhexamid, flubeneteram, fluxapyroxad, isotianil, metsulfovax, ofurace, oxadixyl, oxycarboxin, penflufen, pyracarbolid, pyraziflumid, sedaxane, thifluzamide, tiadinil, vangard, benodanil, flutolanil, mebenil, mepronil, salicylanilide, tecloftalam, fenfuram, furalaxyl, furcarbanil, methfuroxam, flusulfamide, tolnifanide, benzohydroxamic acid, fluopicolide, fluopimomide, fluopyram, tioxymid, trichlamide, zarilamid, zoxamide, cyclafuramid, furmecyclox, dichlofluanid, tolylfluanid, fenpicoxamid, florylpicoxamid, benzovindiflupyr, bixafen, flubeneteram, fluindapyr, fluxapyroxad, furametpyr, inpyrfluxam, isopyrazam, penflufen, penthiopyrad, pydiflumetofen, pyrapropoyne, sedaxane, amisulbrom, cyazofamid, dimefluazole, benthiavalicarb, iprovalicarb, aurcofungin, blasticidin-S, cycloheximide, fenpicoxamid, griseofulvin, kasugamycin, moroxydine, natamycin, ningnanmycin, polyoxins, polyoxorim, streptomycin, validamycin, fluoxastrobin, mandestrobin, pyribencarb, azoxystrobin, bifujunzhi, coumoxystrobin, enoxastrobin, flufenoxystrobin, jiaxiangjunzhi, picoxystrobin, pyraoxystrobin, pyraclostrobin, pyrametostrobin, triclopyricarb, dimoxystrobin, fenaminstrobin, metominostrobin, orysastrobin, kresoxim-methyl, trifloxystrobin, biphenyl chlorodinitronaphthalene, chloroneb, chlorothalonil, cresol, dicloran, fenjuntong, hexachlorobenzene, pentachlorophenol, quintozene, sodium pentachlorophenate, tecnazene, thiocyanatodinitrobenzene, trichlorotrinitrobenzene, asomate, urbacide, metrafenone, pyriofenone, albendazole, benomyl, carbendazim, chlorfenazole, cypendazole, debacarb, dimefluazole, fuberidazole, mecarbinzid, rabenzazole, thiabendazole, furophanate, thiophanate, thiophanate-methyl, bentaluron, benthiavalicarb, benthiazole, chlobenthiazone, dichlobentiazox, probenazole, allicin, berberine, carvacrol, carvone, osthol, sanguinarine, santonin, bithionol, dichlorophen, diphenylamine, hexachlorophene, parinol, benthiavalicarb, furophanatc, iodocarb, iprovalicarb, picarbutrazox, propamocarb, pyribencarb, thiophanate, thiophanate-methyl, tolprocarb, albendazole, benomyl, carbendazim, cypendazole, debacarb, mecarbinzid, diethofencarb, pyrametostrobin, triclopyricarb, climbazole, clotrimazole, imazalil, oxpoconazole, prochloraz, triflumizole, azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, imibenconazole, ipconazole, ipfentrifluconazole, mefentrifluconazole, metconazole, myclobutanil, penconazole, propiconazole, prothioconazole, quinconazole, simeconazole, tebuconazole, tetraconazole, triadimefon, triadimenol, triticonazole, uniconazole, uniconazole-P, acypetacs-copper, basic copper carbonate, basic copper sulfate, Bordeaux mixture, Burgundy mixture, Cheshunt mixture, copper acetate, copper hydroxide, copper naphthenate, copper oleate, copper oxychloride, copper silicate, copper sulfate, copper zinc chromate, cufraneb, cuprobam, cuprous oxide, mancopper, oxine-copper, saisentong, thiodiazole-copper, benzamacril, phenamacril, famoxadone, fluoroimide, chlozolinate, dichlozoline, iprodione, isovaledione, myclozolin, procymidone, vinclozolin, captafol, captan, ditalimfos, folpet, thiochlorfenphim, binapacryl, dinobuton, dinocap, dinocap-4, dinocap-6, meptyldinocap, dinocton, dinopenton, dinosulfon, dinoterbon, DNOC, amobam, asomate, azithiram, carbamorph, cufraneb, cuprobam, disulfiram, ferbam, metam, nabam, tecoram, thiram, urbacide, ziram, dazomet, etem, milneb, mancopper, mancozeb, maneb, metiram, polycarbamate, propineb, zineb, isoprothiolane, saijunmao, allyl isothiocyanate, carbon disulfide, cyanogen, dimethyl disulfide, methyl bromide, methyl iodide, methyl isothiocyanate, sodium tetrathiocarbonate, benquinox, chloroinconazide, cyazofamid, fenamidone, fenapanil, glyodin, iprodione, isovaledione, pefurazoate, triazoxide, climbazole, clotrimazole, imazalil, oxpoconazole, prochloraz, triflumizole, potassium azide, potassium thiocyanate, sodium azide, sulfur, mercuric chloride, mercuric oxide, mercurous chloride, (3-ethoxypropyl)mercury bromide, ethylmercury acetate, ethylmercury bromide, ethylmercury chloride, ethylmercury 2,3-dihydroxypropyl mercaptide, ethylmercury phosphate, N-(ethylmercury)-p-toluenesulfonanilide, hydrargaphen, 2-methoxyethylmercury chloride, methylmercury benzoate, methylmercury dicyandiamide, methylmercury pentachlorophenoxide, 8-phenylmercurioxyquinoline, phenylmercuriurcaphenylmercury acetate, phenylmercury chloride, phenylmercury derivative of pyrocatechol, phenylmercury nitrate, phenylmercury salicylate, thiomersal, tolylmercury acetate, aldimorph, benzamorf, carbamorph, dimethomorph, dodemorph, fenpropimorph, flumorph, tridemorph, trimorphamide, ampropylfos, ditalimfos, EBP, edifenphos, fosetyl, hexylthiofos, inezin, iprobenfos, izopamfos, kejunlin, phosdiphen, pyrazophos, tolclofos-methyl, triamiphos, decafentin, fentin, tributyltin oxide, carboxin, oxycarboxin, chlozolinate, dichlozoline, drazoxolon, famoxadone, fluoxapiprolin, hymexazol, metazoxolon, myclozolin, oxadixyl, oxathiapiprolin, pyrisoxazole, vinclozolin, barium polysulfide, calcium polysulfide, potassium polysulfide, sodium polysulfide, oxathiapiprolin, fluoxapiprolin, rabenzazole, fenpyrazamine, metyltetraprole, pyraclostrobin, pyrametostrobin, pyraoxystrobin, benzovindiflupyr, bixafen, flubeneteram, fluindapyr, fluxapyroxad, furametpyr, inpyrfluxam, isoflucypram, isopyrazam, penflufen, penthiopyrad, pydiflumetofen, sedaxane, pyridachlometyl, aminopyrifen, boscalid, buthiobate, dipyrithione, fluazinam, fluopicolide, fluopyram, parinol, picarbutrazox, pyribencarb, pyridinitril, pyrifenox, pyrisoxazole, pyroxychlor, pyroxyfur, triclopyricarb, bupirimate, diflumetorim, dimethirimol, ethirimol, fenarimol, ferimzone, nuarimol, triarimol, cyprodinil, mepanipyrim, pyrimethanil, dimetachlone, fenpiclonil, fludioxonil, fluoroimide, berberine, sanguinarine, ethoxyquin, halacrinate, 8-hydroxyquinoline sulfate, ipflufenoquin, quinacetol, quinofumclin, quinoxyfon, tebufloquin, chloranil, dichlone, dithianon, chinomethionat, chlorquinox, thioquinox, metyltetraprole, picarbutrazox, etridiazole, saisentong, thiodiazole-copper, zinc thiazole, dichlobentiazox, ethaboxam, fluoxapiprolin, isotianil, metsulfovax, octhilinone, oxathiapiprolin, thiabendazole, thifluzamide, flutianil, thiadifluor, methasulfocarb, prothiocarb, ethaboxam, isofetamid, penthiopyrad, silthiofam, thicyofen, anilazine amisulbrom, bitertanol, fluotrimazole, triazbutil, azaconazole, bromuconazole, cyproconazole, diclobutrazol, difenoconazole, diniconazole, diniconazole-M, epoxiconazole, etaconazole, fenbuconazole, fluquinconazole, flusilazole, flutriafol, furconazole, furconazole-cis, hexaconazole, huanjunzuo, imibenconazole, ipconazole, metconazole, myclobutanil, penconazole, propiconazole, prothioconazole, quinconazole, simeconazole, tebuconazole, tetraconazole, triadimefon, triadimenol, triticonazole, uniconazole, uniconazole-P, ametoctradin, bentaluron, pencycuron, quinazamid, acypetacs-zinc, copper zinc chromate, cufraneb, mancozeb, metiram, polycarbamate, polyoxorim-zinc, propineb, zinc naphthenate, zinc thiazole, zinc trichlorophenate, zineb, ziram, acibenzolar, acypetacs, allyl alcohol, benzalkonium chloride, bethoxazin, bromothalonil, chitosan, chloropicrin, DBCP, dehydroacetic acid, diclomezine, diethyl pyrocarbonate, dipymetrone, ethylicin, fenaminosulf, fenitropan, fenpropidin, formadehyde, furfural, hexachlorobutadiene, nitrostyrene, nitrothal-isopropyl, OCH, oxyfenthiin, pentachlorophenyl laurate, 2-phenylphenol, phthalide, piperalin, propamidine, proquinazid, pyroquilon, sodium o-phenylphenoxide, spiroxamine, sultropen, and tricyclazole.

Combinations of fungicides specifically contemplated for use with the system and method described include: pyraclostrobin and tebuconazole; mefentrifluconazole and pyraclostrobin; azoxystrobin and propiconazole; benzovindiflupyr, azoxystrobin and propiconazole; bixafen and flutriafol; azoxystrobin, propiconazole, and pydiflumetofen; flutriafol and azoxystrobin; picoxystrobin and cyproconazole; fluoxastrobin and flutriafol; fluoxastrobin and flutriafol; prothioconazole and trifloxystrobin; mefentrifluconazole, pyraclostrobin, and fluxapyroxad; fluxapyroxad and pyraclostrobin; tetraconazole and azoxystrobin; prothioconazole and trifloxystrobin; prothioconazole, trifloxystrobin, and fluopyram; and fluopyram and prothioconazole.

The use of the spray timing methodology described above was field-tested with the combination of cyproconazole and picoxystrobin. Specifically, assessments were performed in strip trials in a variety of locations in the eastern United States. Side-by-side plots (areas within the field) of corn were subjected to treatment with a combination of picoxystrobin and cyproconazole (Aproach® Prima, Corteva Agriscience) at a timing dictated by the method disclosed above. Adjacent plots were treated with the same combination of fungicides, but at a time indicated by grower standard practices such as physical scouting for evidence of disease, wetness, or rule of thumb (i.e., crop growth stage, etc.). Also, check plots were employed, within the same field, where no fungicide was applied to look at return of investment (+/−).

The inputs to the method for each plot included data as to the soil data layers. Weather data for each site was obtained from a third-party provider. Additionally, management data was assembled for each plot including, but not limited to, the previous plots planted crop, tillage practice, nitrogen management, planting rate, the planting date and any relevant disease tolerance arising from the hybrid variety.

A comparison was made between the use of the two-active-ingredient combination of fungicides, using either the disclosed method for automating the timing of fungicide applications or current grower standard practices, with check plots in which no fungicide was applied. The use of the disclosed method for prescribing the timing of fungicide application resulted in an average yield advantage of over 4 bushels per acre when compared with application of the same fungicide combination using grower standard practices for timing, and over 10 bushels per acre when compared with check plots in which fungicide was not applied.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. The steps of the methods described herein are described as being performed in a particular order for the purposes of discussion. A person having ordinary skill in the art will understand that the steps of any methods discussed herein may be performed in any order and that any of the steps may be omitted, combined, and/or expanded without deviating from the scope of the present disclosure. Furthermore, the methods described herein may be performed using any manner of device, system, and/or apparatus including the computing devices, computing systems, and/or computing apparatuses that are described herein.

What is claimed is:

1. A system for spraying at least one fungicide onto a crop based on a timing schedule, the system comprising:
a soil analyzer configured to:
acquire samples of soil from a region comprising the crop; and
generate soil data based on the samples of soil;
an automated weather station configured to:
monitor environmental conditions within the region comprising the crop; and
generate environmental data based on the environmental conditions monitored by the automated weather station;
a computing device configured to:
acquire agronomic data comprising information associated with a tillage practice, a crop history, and a fertilization history;
acquire crop genotype data comprising a genotype and pathogen resistance characteristics of the crop;
acquire, based on the environmental data, a weather forecast for the region comprising the crop;
generate, based on inputting the weather forecast, the soil data, the agronomic data, and the crop genotype data into one or more machine learning models, a predicted disease severity for the crop in the region over a plurality of time intervals;
generate, based on the predicted disease severity and a sensitivity threshold, a fungicide timing schedule comprising the plurality of time intervals at which to spray the at least one fungicide onto the crop, wherein the sensitivity threshold is associated with the predicted disease severity at which spraying the at least one fungicide onto the crop is initiated; and
based on the predicted disease severity meeting one or more criteria, send the fungicide timing schedule to a fungicide spraying device; and
the fungicide spraying device configured to:
receive the fungicide timing schedule; and
spray the at least one fungicide onto the crop based on the fungicide timing schedule.

2. The system of claim 1, wherein the fungicide spraying device comprises an aerial sprayer configured to spray the fungicide onto the crop from an aircraft flying over the crop, a ground sprayer comprising an overhead spray boom that is ground-based and configured to spray the fungicide onto the crop from above the crop, or an undercover sprayer that is ground-based and configured to spray the fungicide onto the crop from beneath the crop.

3. The system of claim 1, wherein the weather forecast comprises a plurality of predicted humidities for the plurality of time intervals, a plurality of predicted rainfalls for the plurality of time intervals, and a plurality of predicted temperatures for the plurality of time intervals, and wherein the computing device is configured to:
determine, based on inputting the plurality of predicted humidities, the plurality of predicted rainfalls, and the plurality of predicted temperatures for the plurality of time intervals into the one or more machine learning models, one or more times at which dew or rain droplets are predicted to form or persist on leaves of the crop, wherein formation or persistence of dew on the leaves of the crop is positively correlated with the predicted disease severity.

4. The system of claim 1, wherein the computing device is further configured to:
generate a user interface comprising a plurality of interface elements corresponding to a plurality of descriptions of the predicted disease severity, wherein the plurality of descriptions comprise a plurality of values associated with disease severity in the crop;
generate, in the user interface, a prompt requesting an input to select one of the plurality of interface elements that indicates a predicted disease severity at which to spray the fungicide onto the crop; and
determine the sensitivity threshold based on the input.

5. A method of causing a modification to a timing of spraying at least one fungicide onto a crop based on a fungicide timing schedule, the method comprising:
acquiring, by a computing device comprising one or more processors, soil data based on samples of soil from a region comprising the crop;
acquiring, by the computing device, environmental data based on environmental conditions within the region comprising the crop;
acquiring, by the computing device, agronomic data comprising information associated with a tillage practice, a crop history, and a fertilization history;
acquiring, by the computing device, crop genotype data comprising a genotype and pathogen resistance characteristics of the crop;
acquiring, by the computing device, based on the environmental data, a weather forecast for the region comprising the crop;
generating, by the computing device, based on inputting the weather forecast, the soil data, the agronomic data, and the crop genotype data into one or more machine learning models, a predicted disease severity for the crop in the region over a plurality of time intervals; and
generating, by the computing device, based on the predicted disease severity and a sensitivity threshold, a fungicide timing schedule comprising the plurality of time intervals at which to spray the at least one fungicide onto the crop, wherein the sensitivity threshold is associated with the predicted disease severity at which spraying the at least one fungicide onto the crop is initiated.

6. The method of claim 5, wherein the one or more machine learning models comprise a leaf wetness model configured to determine a leaf wetness for the crop in the region based on the environmental data, wherein the environmental data comprises information associated with dew formation, precipitation, or temperature in the region, and wherein the leaf wetness of the crop is positively correlated with the predicted disease severity of the crop.

7. The method of claim 5, wherein the predicted disease severity is positively correlated with a proportion of leaves of the crop that are predicted to be covered in foliar lesions.

8. The method of claim 5, wherein the agronomic data comprises a planting date of the crop, a planting rate of the crop, a planting density of the crop, an irrigation practice, a nitrogen fertilizer amount per square meter of the region, or a crop rotation history for the crop.

9. The method of claim 5, wherein the soil data comprises a cation exchange capacity of soil in the region, an organic matter percentage of the soil, a sand percentage of the soil, a silt percentage of the soil, a clay percentage of the soil, a potential of hydrogen (pH) of the soil, or a slope of surface of the soil.

10. The method of claim 5, wherein the crop genotype data comprises one or more disease tolerance scores indicating a resistance of the crop to one or more pathogens, and wherein the predicted disease severity is inversely correlated with the one or more disease tolerance scores of the crop, and wherein each of the one or more pathogens is associated with a temperature range or a humidity range that increase the predicted disease severity for the crop.

11. The method of claim 5, wherein the one or more machine learning models are configured to determine the predicted disease severity in a plurality of sub-regions of the region, and further comprising:
generating a disease severity map for the region, wherein the disease severity map comprises a plurality of indications of the predicted disease severity in each of the plurality of sub-regions.

12. The method of claim 5, wherein the crop is selected from corn, soy, cotton, and canola.

13. The method of claim 12, wherein the crop is corn, and one or more machine learning models are configured to determine the predicted disease severity caused by one or more diseases comprising northern corn leaf blight, gray leaf spot, or tar spot.

14. The method of claim 5, wherein the environmental data comprises growing degree days associated with the crop, and wherein the growing degree days are positively correlated with the predicted disease severity.

15. The method of claim 5, wherein the crop is corn, and predicted disease severity corresponds to a predicted severity of foliar disease on the corn, a predicted severity of seed rot in the corn, a predicted severity of seedling blight in the corn, a predicted severity of stalk rot in the corn, or a predicted severity of ear rot in the corn.

16. The method of claim 5, wherein the one or more machine learning models comprise a neural network, a random forest model, a linear model, or a support vector regressor, and wherein the one or more machine learning models are configured to determine a risk of the crop being infected by one or more pathogens.

17. The method of claim 5, wherein the environmental data comprises historical weather conditions for the region, a short-term forecast of weather conditions within a short-term time period, or a long-term forecast of weather conditions within a long-term time period comprising a time period subsequent to the short-term time period.

18. The method of claim 5, wherein the fungicide timing schedule comprises a recommendation of an amount of two or more types of fungicide to spray onto the crop.

19. The method of claim 5, wherein the soil data comprises a soil moisture for the region or an available water content for the region, and wherein the soil moisture or the available water content are positively correlated with the predicted disease severity.

20. The method of claim 5, wherein the predicted disease severity is associated with a plurality of disease severity scores, wherein the plurality of disease severity scores are positively correlated with disease severity, and wherein the predicted disease severity meets the one or more criteria based on at least one of the plurality of disease severity scores exceeding the sensitivity threshold.

21. The method of claim 18, wherein the two or more types of fungicide are selected from the group consisting of: mefentrifluconazole and pyraclostrobin; axoxystrobin and propiconazole; benzovindiflupyr, azoxystrobin and propiconazole; bixafen and flutriafol; azoxystrobin, propiconazole, and pydiflumetofen; flutriafol and azoxystrobin; picoxystrobin and cyproconazole; fluoxastrobin and flutriafol; fluoxastrobin and flutriafol; prothioconazole and trifloxystrobin; mefentrifluconazole, pyraclostrobin, and fluxapyroxad; fluxapyroxad and pyraclostrobin; tetraconazole and azoxystrobin; prothioconazole and trifloxystrobin; prothioconazole, trifloxystrobin, and fluoryram; and fluopyram and prothioconazole.

22. One or more non-transitory computer readable media comprising instructions that, when executed by at least one processor, cause a computing device to perform operations comprising:
acquiring soil data based on samples of soil from a region comprising a crop;
acquiring environmental data based on environmental conditions within the region comprising the crop;
acquiring agronomic data comprising information associated with a tillage practice, a crop history, and a fertilization history;
acquiring crop genotype data comprising a genotype and pathogen resistance characteristics of the crop;
acquiring, based on the environmental data, a weather forecast for the region comprising the crop;
generating, based on inputting the weather forecast, the soil data, the agronomic data, and the crop genotype data into one or more machine learning models, a predicted disease severity for the crop in the region over a plurality of time intervals;
generating, based on the predicted disease severity and a sensitivity threshold, a fungicide timing schedule comprising the plurality of time intervals at which to apply fungicide to the crop, wherein the sensitivity threshold is associated with the predicted disease severity at which application of the fungicide to the crop is initiated; and
based on the predicted disease severity meeting one or more criteria, sending the fungicide timing schedule to a fungicide application device configured to apply the fungicide to the crop.
